(19) United States
(12) Patent Application Publication
(10) Pub. No.: US 2025/0061191 A1
(43) Pub. Date: Feb. 20, 2025

(54) STATISTICAL OBJECT IDENTIFICATION

(71) Applicant: Invisinet Technologies LLC, Houston, TX (US)

(72) Inventor: John W. Hayes, Clearwater Beach, FL (US)

(21) Appl. No.: 18/235,682

(22) Filed: Aug. 18, 2023

(51) Int. Cl. G06F 21/55; G06F 17/18

(52) U.S. Cl. CPC G06F 21/552; G06F 17/18; G06F 2221/034

(57) ABSTRACT

A mechanism is disclosed to communicate an original object (12S) without requiring the sending of the complete original object. A representation of the original object (12S), a statistical object (14S), is generated by one entity and is communicated to a second entity. The second entity receives the statistical object (14S), and identifies it as being generated from an original object (12S). If the second entity is unable to unambiguously identify the statistical object (14S), the second entity records the partial identity progress and associated communications characteristics information (22). The amount of information communicated during this process is much smaller than the original object (12S), greatly improving the speed and efficiency of communicating an original object (12S). If the second entity is unable to match the received statistical object (14S) to any stored statistical object, an attack measurement (13S) is generated, and further processing of the received statistical object (14S) ends.

### CROSS REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

This disclosure relates to the field of computer security. More particularly, the present disclosure relates to methods for uniquely identifying an original object from a series of statistical objects by receiving and identifying the original object from which the statistical objects were generated.

It is known that security devices employ countermeasures to thwart attempts to break, compromise, limit, bypass, or disable the system. Security devices operating within a computer network operate by classifying network communications into good communications and bad communications and blocking the bad communications. Network security devices may use the source network address of the network communication as a bad communication filtering mechanism.

Within computer networks, network communications from multiple different devices may be re-addressed to appear coming from a single network address. The technology that re-addresses network communications is called Network Address Translation (NAT). When the use of NAT technology is combined with network security devices that block network communications based on their source network address, good communications may be inadvertently blocked along with bad communications.

Statistical objects are used where conventional secured communications of an original object cannot be used due to protocol constraints or communications bandwidth limitations. Using a statistical object instead of an original object achieves much greater bandwidth efficiency due to the use of a deterministic statistical representation of the original object.

In this disclosure, the term “statistical object” is a string of values mapped by a random or “hash” function. The output of this function is a string of values which stands for or represents the input to the function. In FIG. 1, the output string of values is shown as x1, x2, x3 . . . xn. In this example, the input of the function is an original object, while the output is a statistical object.

If the output string is shorter than the input string, a “collision” occurs. A collision results when two or more different inputs produce the same output, which is generally considered detrimental.

To mitigate the effects of collisions, additional inputs can be added to the function. These additional inputs may vary over time, enabling different streams of statistical objects eventually to diverge from their colliding tendencies. As an example, a clock may be employed to add a time value as an input. As another example a counter may serve as an input. Multiple additional inputs may be used together in the generation of the statistical object. This is illustrated in FIG. 1.

In this disclosure, the terms “function,” “random function” and “hash function” are intended to include any procedure or mathematical method that converts a large amount of data into a smaller amount of data. In one embodiment, the output may be a single integer or value which serves as an index to an array or database. The output values of a hash function may be referred to as hash values, hash codes, hash sums, checksums, or hashes. The inputs to a hash function may be referred to as keys.

FIG. 2 illustrates a simple example of the operation of a hash function. A set of four inputs or keys are shown as the names Joe, Moe, Sam, and Charlie. The hash function [symbol] (x) associates a hash or output with each name. The input of Joe causes the hash function to point to output “03”. The input of Moe causes the hash function to point to the output of “01”. The input of Sam causes the hash function to point to the output of “06”. The input of Charlie causes the hash function to point to the output of “03”. Because the Joe and Charlie inputs both return a hash of “03”, this pair of hashes is said to cause a collision.

As noted above, this collision may be avoided by adding a clock or a counter as an additional input to the hash function. So, in an example embodiment, if the input of Joe is provided to the hash function at a clock time of 1:00 p.m. (13:00), and the input of Charlie is provided to the hash function at a clock time of 2:00 p.m. (14:00), the different inputs would lessen the probability that this collision would occur.

One possible advantage of using statistical objects is that information may be “concentrated” in a relatively fewer number of transmitted bits, which increases the efficiency of communication across a network.

A consequence of using a deterministic statistical representation is that the representation is not guaranteed to identify uniquely to the source original object. The deterministic statistical representation, which is the statistical object, may be generally considered to be the output of a hash or similar function applied to the original object along with one or more varying deterministic inputs such as a clock or counter. These varying deterministic inputs are necessary so that the cumulative stream of output statistical objects generated from a single original object is generally unique across a large number generated statistical objects. Unambiguously identifying a statistical object to a unique original object is essentially an exercise in mitigating the effects of the “birthday problem.” The birthday problem is the probability that output of the hash of different original objects and their respective deterministic inputs produce identical statistical objects. The generation of a single statistical object by two or more original objects, as explained previously, causes a collision.

FIG. 3 shows a graph that illustrates the birthday problem. The number of individuals in any given group is shown on the x-axis. The y-axis shows an approximate probability, on a scale from zero to one, that two individuals in the group share the same birthday. As an example, in a group of twenty-three people, the probability that two persons in this group will have the same birthday is about fifty percent.

The birthday problem may be understood as an example of the hash function depicted in FIG. 2. In the birthday problem, the keys or inputs may be the names of the individuals in the group. The hash function maps these inputs to one of the hashes or outputs, which represent the days of the year. If two persons in the group share the same birthday, the hash function points to the same day for two different individuals, and a collision occurs.

Given a uniform distribution, the probability of a collision increases with the number of statistical objects in use. A mechanism to unambiguously identify statistical objects back to their original objects would constitute a major technological advance and would satisfy long felt needs the cyber security industry.

The present disclosure provides a method for discarding bad communications without blocking good communications when both communications have the same source network address. The development of such a system would constitute a major technological advance and would satisfy long felt needs and aspirations in the network security industry.

Statistical Object Identification is described in U.S. Pat. No. 8,572,697, entitled Method for Statistical Object Identification. The '697 patent describes statistical object identification but does not describe any countermeasures employed by statistical object identification.

Statistical Object Identification is also described in U.S. Pat. No. 9,973,499 entitled Method for Statistical Object Identification. The '499 patent describes statistical object identification, and describes countermeasures employed by statistical object identification that blocks all communications from a network address for a period of time.

### SUMMARY

A method according to the present disclosure includes accepting as input to a device a communication of a first statistical object having communications characteristics. The device includes a table storing a plurality of statistical objects, each of which corresponds to a respective one of a plurality of original objects. The device includes a statistical object matcher, an accumulated statistical object selector, an original object identifier, an attack measurement accumulator, a probability calculator, and a threshold comparator. The statistical object matcher determines if said the statistical object matches at least one of the plurality of statistical objects in the table. The statistical object matcher communicates an attack measurement to the attack measurement accumulator when the first statistical object matches none of the plurality of statistical objects in the table. The accumulated statistical object selector obtains and accumulates the statistical object and a plurality of matched statistical objects in an accumulated statistical object identified by the communications characteristics when the first statistical object matches at least one of the plurality of statistical objects stored in the table. The original object identifier determines if the accumulated statistical object can be produced by exactly one original object of the plurality of original objects stored in the table, and selects the exactly one original object from the plurality of original objects. An accumulated attack measurement is generated by accumulating a plurality of attack measurements generated during a time period in which the accumulated statistical object is accumulated. The probability calculator determines a calculated probability of guessing the accumulated statistical object based on the accumulated statistical object and a number of statistical objects in the plurality of statistical objects and the accumulated attack measurement. The threshold comparator determines if the calculated probability is less than a threshold value, and an indication of the selected original object is generated.

In some embodiments, the probability of guessing the first statistical object remains constant, while the number of statistical objects in the plurality of statistical objects varies.

In some embodiments, the probability of guessing the accumulated statistical object remains constant, while the number of statistical objects in the plurality of statistical objects varies.

In some embodiments, the accumulated statistical object in the plurality of accumulated statistical objects is removed after a period of inactivity pertaining to the accumulated statistical object.

In some embodiments, the threshold value can be changed without coordination with the source of the first statistical object.

In some embodiments, the threshold value can be changed without communication with the source of the first statistical object.

In some embodiments, the threshold value is associated with the selected original object.

In some embodiments, the threshold value is associated with the device.

In some embodiments, the threshold value is associated with the plurality of original objects.

In some embodiments, the indication includes clock information used in the generation of the first statistical object.

In some embodiments, the indication includes keying information used in the generation of the first statistical object.

In some embodiments, the indication includes state information used in the generation of the first statistical object.

In some embodiments, the indication includes additional information used in the generation of the first statistical object.

In some embodiments, the communications characteristics includes TCP/IP session information.

In some embodiments, the communications characteristics includes addressing information.

In some embodiments, the communications characteristics includes security association information.

In some embodiments, a probability of guessing the first statistical object remains constant, while the number of attack measurements in the plurality of attack measurements varies.

In some embodiments, a probability of guessing the first statistical object accounts for brute force attacks.

In some embodiments, the communications characteristics includes time information.

In some embodiments, the selected original object is determined with the communications characteristics while the statistical object matcher is creating the attack measurement from communications with the same the communications characteristics.

Additional aspects, possible advantages and embodiments according to the present disclosure will become apparent to those skilled in the art from the following description of various example embodiments and related drawings, and the claims following.

### BRIEF DESCRIPTION OF THE DRAWINGS

FIG. 1 illustrates the general operation of a hash function.

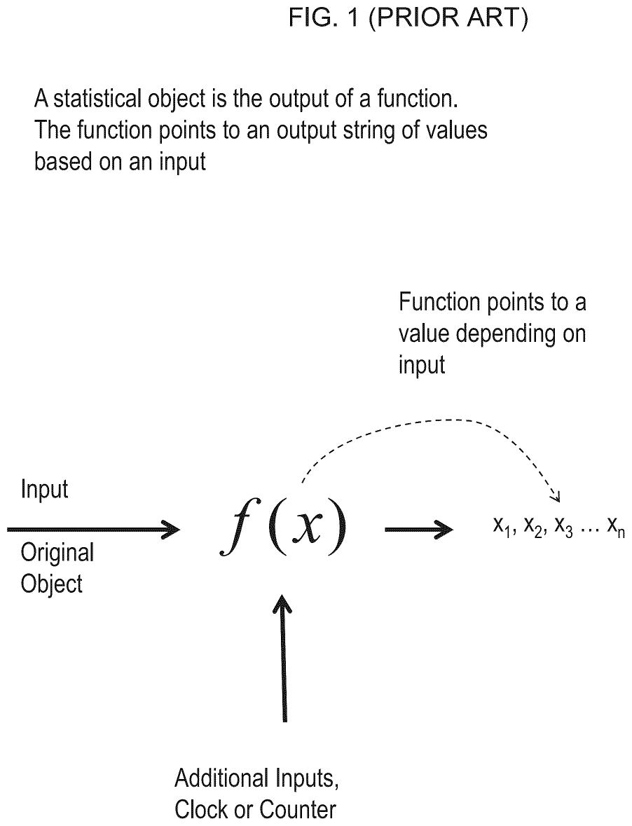

FIG. 2 shows how the hash function illustrated in FIG. 1 maps a set of inputs to a set of outputs.

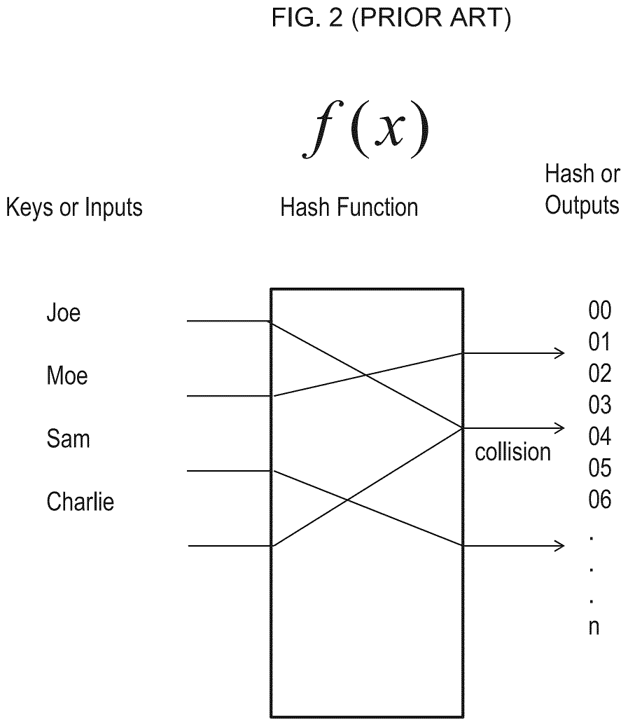

FIG. 3 is a graph that illustrates the birthday problem.

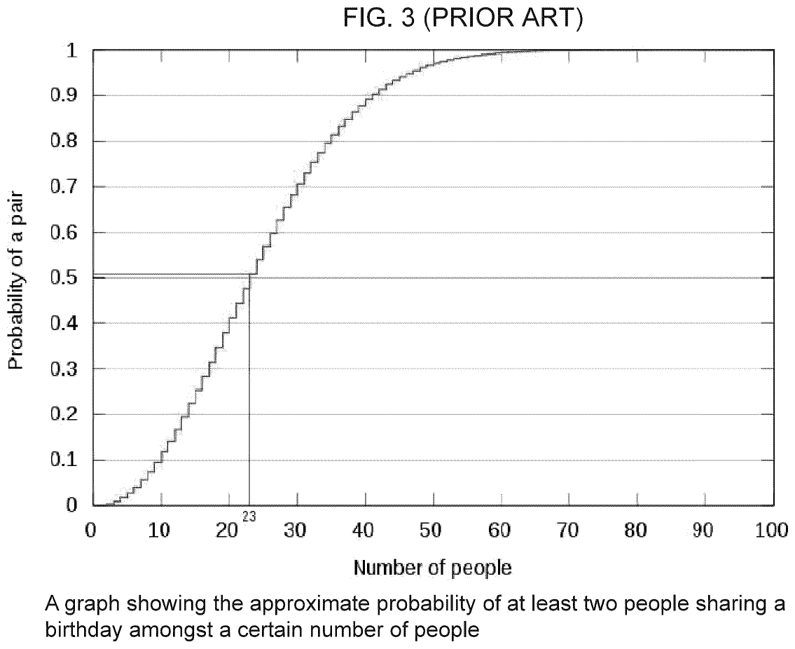

FIG. 4 is an illustration which shows an embodiment according to the present disclosure.

FIG. 5 is an illustration which shows another embodiment according to the present disclosure.

FIG. 6 illustrates certificates that are used to authenticate a communication.

FIG. 7 shows certificates stored in a remote system.

FIG. 8 shows that certificates are too large to send to the remote system in their original form.

FIG. 9 depicts a solution: converting the certificates, which are original objects, to cryptographic hashes, or statistical objects.

FIG. 10 shows how statistical objects and a time value from a clock are sent to the remote system.

FIG. 11 illustrates the result of the conversion of three original objects to three statistical objects.

FIG. 12 furnishes a view of Ben's first communication with the remote system.

FIG. 13 depicts the comparison process that occurs within a statistical object matcher.

FIG. 14 illustrates the role of an accumulated statistical object selector.

FIG. 15 illustrates the function of an accumulated statistical object selector.

FIG. 16 illustrates the task of an original object identifier.

FIG. 17 shows that Ben's first communication has failed to be authenticated.

FIG. 18 supplies a schematic view of Ben's second attempt to communicate with the remote system.

FIG. 19 depicts the second communication, and the resulting match that is produced in the statistical object matcher.

FIG. 20 illustrates the process of finding a match.

FIG. 21 shows how the accumulated statistical object selector discards statistical objects that do not lead to an authenticating match.

FIG. 22 furnishes a view of a probability calculator, which computes the probability of a successful guess of accumulated statistical object information.

FIG. 23 reveals the function of a threshold comparator, which compares the calculated probability to a probability threshold value.

FIG. 24 exhibits the final result, the authentication of Ben's second communication.

FIG. 25 shows the relationships of statistical objects and attack measurements over time.

### DETAILED DESCRIPTION

### I. Principles

A statistical object is a deterministic statistical representation of an original object. A statistical object as that term is used herein may be generally considered to be the output of a “hash” or similar function coupled with additional inputs of clocks, counters, and other various deterministic inputs. Unambiguously identifying a statistical object as representing a unique original object is essentially an exercise in mitigating the effects of the “birthday problem” explained in the Background section herein. The birthday problem is the probability that the output of the hash function for different original objects and their associated deterministic inputs is in the form of identical statistical objects. As explained in the Background section herein, generation of a single statistical object by two or more original objects causes a collision. The probability of a collision increases with the number of statistical objects in use. Statistical objects are designed to be used as components of security devices. As a component to security devices, in addition to uniquely identifying a statistical object with the correct original object, the overall probability of guessing any valid statistical object must also be considered. Guessing a valid statistical object by an attacker may enable unauthorized access to a computer system or network, and is the result intended to be avoided. The amount of space available to carry a statistical object will vary with the communications mechanism, but the size of an individual statistical object is expected to remain small, generally less than the number of bits required to uniquely identify an original object when large numbers of objects are in use. This requires the aggregation of two or more related statistical objects into a larger aggregate statistical object. Aggregating multiple related statistical objects into a single aggregate statistical object requires that all possible original object resolution matches are tracked and maintained. Multiple statistical objects from the same original object can be associated together by using information associated with the communication and reception of the statistical objects. This information, called communications characteristics, can include networking information, such as the source address or network session information including source and destination addresses and source and destination port numbers. Communications characteristics can also include physical information such as the physical port upon which the statistical object was received or the logical channel upon which the statistical object was received.

To unambiguously identify the original object from which a statistical object or a stream of statistical objects was generated, the device performing the identification can maintain a table of all valid statistical objects. The table may contain collisions where multiple original objects generate the same statistical object. The table may contain clock dentations (timestamps) indicating when each entry of data is added to the table. When a statistical object is received, it is first looked up in the table of all statistical objects to determine if the received statistical object is valid. If the received statistical object is not found (i.e., is not matched to any entry) in the table, then no further processing occurs with respect to identifying the original object on that particular statistical object reception. When a statistical object is received and is not matched in the table, it is considered as an attack on the device or system, and a counter associated with the current time period is incremented. Attack counters are maintained for each time period, corresponding to the statistical object detection timestamps. When a statistical object is received and is matched in the table of all valid statistical objects, the communications characteristics associated with reception of the matched statistical object and the list of all potential original objects are recorded. If the list of potential original objects has exactly a single entry, then the original object is identified, and the process moves on to calculating statistical probability. It will be appreciated that “table” as that term is used herein may be a logical element within a computer or computer system in which logical entries are separately and individually addressable.

When a statistical object is received and is not unambiguously identified (i.e., matched to a single original object in the table) and therefore represents a partially identified statistical object, the partially identified statistical object and the list of potential original objects associated with such statistical object are recorded along with the communications characteristics associated with the reception of the statistical object. When another statistical object with related communications characteristics is received, the list of potential original objects is pruned of original objects that cannot generate the complete set of received statistical objects found in the aggregate statistical object. Once the original object is unambiguously identified, the process moves on to calculating the statistical probability of guessing the information in the aggregate statistical object. If the original object is not unambiguously identified, nothing further is done at such time and the system awaits the reception of another statistical object with related communications characteristics to increase the number of bits of information received, and again aggregates this information into an aggregate statistical object; the process then repeats itself.

Calculating the probability of guessing the information in the aggregate statistical object requires the number of bits of statistical objects that have been received and aggregated and the number of statistical objects maintained in the table of all valid statistical objects. The specific probability p of a collision is

$$p ( n ; d ) = \frac{d !}{{d}^{n} ( d - n ) !}$$

where n is the number of statistical objects in the table of valid statistical objects and d is the total number of unique statistical objects in the cache plus the attack counter values for attacks occurring during the token validity period. For general use, the approximation

$$p ( n ; d ) \approx 1 - {e}^{- {n}^{2} / ( 2 \times d )}$$

is used. The total number of unique statistical objects available dis d=2^{b} where b is the number of bits of statistical object information received.

Once the probability has been calculated, it is compared with a probability threshold. If the calculated probability is less than the probability threshold, then the statistical object has been identified with a confidence that the aggregate information received does not exceed the probability threshold set beforehand. If the probability exceeds the threshold, nothing further is done, and the system awaits the reception of another statistical object with related communications characteristics to increase the number of bits of information received, and aggregates the information into the accumulated statistical object; the process then repeats itself.

A further optimization can be made by associating communications characteristics across multiple identifications of statistical objects. When a statistical object is identified and does not exceed the probability threshold, thereby confirming that it was generated from the original object, the communications characteristics are temporarily associated with that original object. When a subsequent statistical object with similar or identical communications characteristics is received, the subsequent received statistical object is checked against the associated original object. If the associated original object could produce the received statistical object, the statistical object is identified as being produced by the associated original object. When multiple original objects are associated with the same set of communications characteristics, the identification of the statistical object proceeds by aggregating the statistical object information and pruning the list of potential original objects until only a single original object remains. The statistical object is still aggregated in an aggregated statistical object to enable the aggregation of information for the probability calculation. The probability calculation is made using the number of bits of information received in the aggregate statistical object and the number of statistical objects that are associated with the communications characteristics that are associated with the original object. This results in a smaller amount of statistical object information being required to not exceed the probability threshold, because the communications characteristics are being used as an additional discriminator. Multiple sets of communications characteristics can be associated with original object and multiple original objects can be associated with a single set of communications characteristics. When a statistical object is identified as being produced by an original object, a timestamp or other mechanism for indicating recent activity is updated in the communications characteristics associated with the original object. A lack of communications characteristics associated with original objects after a period of time should have their association removed after such periods of inactivity exceed a threshold. Subsequent statistical object reception with those removed communications characteristics will proceed as unassociated communications until those communications are again associated with an original object.

To ensure that the security of the statistical objects being produced cannot be readily captured, copied, and replayed as original, the algorithms used to generate the statistical objects may use additional information beyond the original object as inputs. This additional information may include, e.g., clock values (timestamps), counters, and other deterministic inputs. During the identification of a statistical object with an original object, this additional information is also identified and used to further validate the identity of the original object.

A probability threshold has several unique uses. Firstly, the use of a probability threshold enables a system for statistical object identity to be used with varying numbers of statistical objects contained within the table of all valid statistical objects, without having the probability of guessing a statistical object increase as statistical objects are added to the valid statistical object table. The system used herein simply requires additional statistical objects, thus increasing the amount of information available to maintain the desired probability. A second unique attribute of using the probability threshold is that the probability threshold can be changed by the entity performing statistical object identification without communication, knowledge, or coordination of the change with the entity generating the statistical object. This is especially important in the context of cyber security where knowledge of a threat or attack may raise the level of security desired. This can be used by the entity receiving the statistical object and performing statistical object identification to decrease the threshold, requiring more statistical information before the original object identity is confirmed. The ability to perform this function without requiring any communication with or notification to the entity producing the statistical object is especially useful.

Additional information can also be conveyed using statistical objects. When additional inputs are used in the generation of the statistical object, this information can be extracted during the statistical object identification process. Examples of such additional information includes, but is not limited to, information regarding the state of some system or process, an index into a table of information or other types of data.

### II. Overview

One limitation of information networks known in the art prior to the present disclosure is that it is difficult to verify or approve a communication before the communication has been allowed to penetrate the network. One reason for this difficulty is that the means of verification, which is called a “certificate,” is too large to send to the network in the initial set of digital information which initiates the communication, and which ultimately leads to an authentication.

One embodiment according to the present disclosure solves the foregoing problem by reducing the information in the certificate which is used to authenticate the communication before it is allowed to proceed (enter the system or network) by converting the certificate to a much smaller “statistical object.” The foregoing method allows the network to determine the identity of the initiator of the communication before the communication is given access to the system or network. This method provides a security feature that substantially eliminates potentially detrimental or malicious attacks that could be perpetrated against the network using conventional identification technology.

One embodiment according to the present disclosure relates to a method for authenticating a communication. In an example set forth in Section VI herein, a communication between a user (referred to as “Ben”) and a remote system is described. Communications received by the remote system must be authenticated before they are allowed. In this disclosure, the terms “authenticate”, and “authentication” are intended to mean that the identity of a communicator or an initiator of a communication has been verified, and that a particular communication is permitted, allowed or otherwise approved to proceed into the remote system.

### Definitions

As used herein, certain terms are defined as follows:

Aggregate Statistical Object-A data structure containing one or more statistical objects, a list of potential original objects that may have created the original object(s) and the communications characteristics that provide the association between multiple statistical objects.

Attack—A failed authentication. With respect to the present disclosure, a failure to match at least one of a plurality of statistical objects.

Authentication—The act of confirming the truth of an attribute claimed true by an entity. Operationally, authentication is the verification that the offered identity credential is authentic and valid for user, process, or device, often as a prerequisite to allowing access to resources in an information system.

Authenticating Device—A device that verifies the identity of a user, process or device.

Authentication Information—Information provided for the purpose of verifying the identity of a user, process, or device.

Brute Force Attack—An attack where the attacker submitting as many attempts as possible. With respect to the present disclosure, in a brute force attack, the attacker submits statistical objects created without knowing the original object.

Communication—A communication is one or more messages conveyed in either direction between the communicating parties.

Communications Characteristics—Any of the characteristics, both physical and logical, that are available to distinguish one communication from another and to group discrete communication events into one or more related sequences of communications events.

Connection—A logical pairing of two devices that enable them to communicate. A connection utilizes a series of packets to accomplish this. A TCP connection is an example of a connection.

Connection Request—A request by one device to another device to create a connection.

Device—A device is any object that is capable of being attached or wirelessly connected to and communicating on a network. Examples of devices include computers, servers, clients, laptops, PDAs, cell phones, smart phones, network appliances, storage systems, virtual appliances, switches, routers, load balancers, caches, intrusion detection systems, VPNs, authentication devices, intrusion prevention systems, and firewalls.

Identity—An identity is a collection of attributes about an entity that distinguish it from all other entities. Entities are any thing with distinct existence, such as people, or devices.

Identity Credential—An identity credential is a set of claims made by an entity about an identity.

Digital Identity—A digital representation of a set of characteristics by which a user, process or device is uniquely recognized.

Hash or Hashing function—Any procedure or mathematical method that converts are large amount of data into a smaller amount of data. In one embodiment of the invention, the output may be a single integer or value which serves as an index to an array or database.

IP is the Internet Protocol. The Internet Protocol is a data-oriented protocol used by devices to communicate across a packet switched network. IP information is carried by an IP header in an IP packet. The IP header contains device address information, protocol control information and user data information.

Network—A network is a collection of computers, servers, clients, routers, and devices that are connected together such that they can communicate with each other. The Internet is an example of a network.

Original Object—The inputs to the function that generates a statistical object. The original object can include additional inputs such as clocks, counters, nonces and other deterministic information.

Protocol—In the field of telecommunications, a protocol is the set of standard rules for data representation, signaling, authentication, error detection and other features required to send information over a communications channel. Not all protocols provide all these features. Protocols with different features may be layered on top of one another to provide a more robust feature set. Examples of protocols are the IP protocol and the TCP protocol. These protocols are often used together and referred to as the TCP/IP protocol.

Public Key Infrastructure (PKI)—A set of policies, processes, server platforms, software and workstations used for the purpose of administering certificates and public-private key pairs, including the ability to issue, maintain, and revoke public key certificates.

PKI Certificate—A set of data that uniquely identifies an entity, contains the entity's public key, and is digitally signed by a trusted party, thereby binding the public key to the entity. Public Key Identity (PKI) certificates are composed of a public key and a private key. The private key is never communicated and, as its name suggests, is kept private. Two entities using or otherwise utilizing PKI certificates exchange public keys, enabling them to determine a shared secret without exposing their private keys. This shared secret is then used for cryptographic purposes such as encryption and authentication. Because the private key is never shared, participants in public key cryptography do not have the ability to impersonate the remote PKI certificate.

Protocol Entity—A device, function, process, or procedure that implements a communications protocol.

Security Protocol—A security protocol is a protocol that performs a security function or a combination of functions such as data confidentiality, integrity, or authentication. Security protocols usually employ cryptographic functions in their operation.

Statistical Object—The output of a function that has a statistical distribution. Commonly, a statistical object is the output of a hashing function.

Symmetric Key—A cryptographic key that is used to perform both the cryptographic operation and its inverse, for example to encrypt and decrypt, or create a message authentication code and to verify the code.

Symmetric Key Authentication—An authentication algorithm that uses a symmetric key to create a message authentication code and to verify the code.

TCP—is the Transmission Control Protocol. Using TCP, networked devices can create connections to one another, over which they can send data. The TCP protocol guarantees that data sent by one endpoint will be received in the same order by the other, and without any pieces missing. The TCP protocol also distinguishes data for different applications (such as a Web server and an email server) on the same device.

### III. Example Embodiments

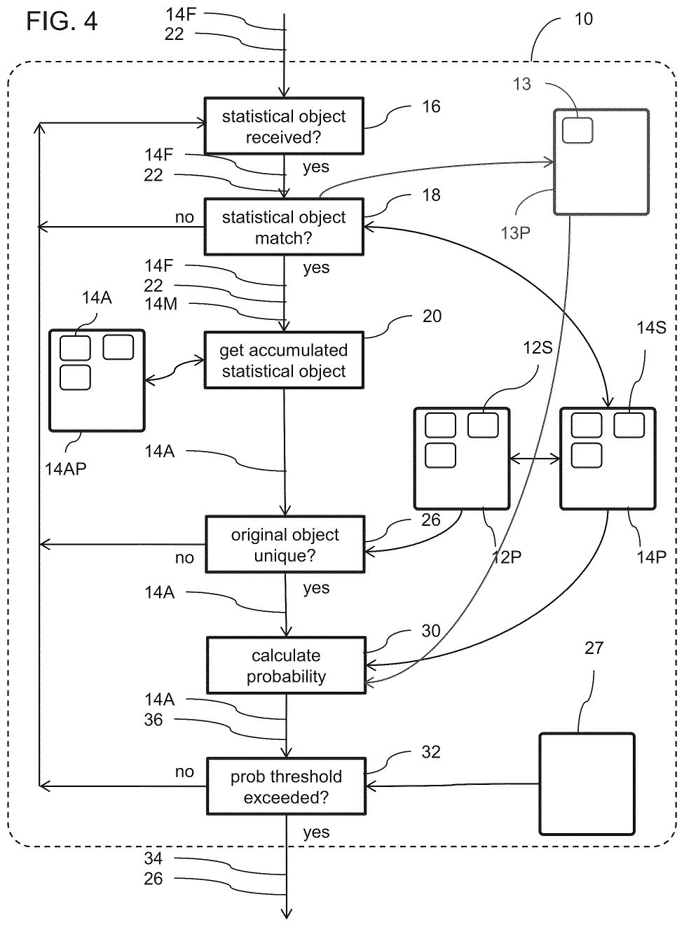

FIG. 4 shows one example embodiment according to the present disclosure, which includes a device 10 intended to communicate with at least one user. As user herein, “connected to” may be direct electrical connection, or connection through one or more intermediate electronic components or systems. In a more general sense, logical components described herein having particular functions may be in signal communication with other logical components of the described device 10. The logical components are not limited to any specific configuration of physical circuitry except as would be understood by those skilled in the art as requiring specific physical components to execute the ascribed logical functions. The logical components may be implemented on one or more or, for example and without limitation, a microcomputer, microprocessor, field programmable gate array, and/or application specific integrated circuit(s).

The device 10 stores and/or processes at least one original object 12S and at least one corresponding statistical object 14S based on the at least one original object (e.g., 12S), e.g., as may be created by application of a hash function. In some embodiments, the device 10 stores and/or processes a plurality of original objects 12P and a plurality of associated statistical objects 14P. In this disclosure, a single original object is identified as 12S (S for singular), while a plurality of original objects is identified by 12P (P for plurality). In this disclosure, a single statistical object is identified as 14S (S for singular), while a plurality of statistical objects is identified by 14P (P for plurality). The term “device” is intended to encompass any suitable means for conveying and/or storing information or data. In an example described in Section VI, the device 10 is a remote system, that is, at a location physically separated from one or more users. In the embodiments described below, the device 10 includes all the other components subsequently described herein.

In one embodiment, the device 10 includes a communications receiver 16 which is in signal communication with an external network, and with a statistical object matcher 18. The statistical object matcher 18 is in signal communication with an accumulated statistical object selector 20 and has access to the plurality of statistical objects 14P stored in the device 10. The statistical object matcher 18 has access to and makes a plurality of attack measurements 13P. The accumulated statistical object selector 20 is in signal communication with an original object identifier 26 and has access to a plurality of accumulated statistical objects 14AP (which may be stored on the device 10 as explained above). The original object identifier 26 is in signal communication with a probability calculator 30 and has access to the plurality of original objects 12P. The probability calculator 30 is in signal communication with a threshold comparator 32 and has access to the plurality of statistical objects 14P and a plurality of attack measurements 13P. The threshold comparator 32 provides the output of the device 10 and has access to a probability threshold value 27 (which may be stored on the device 10 or communicated from elsewhere).

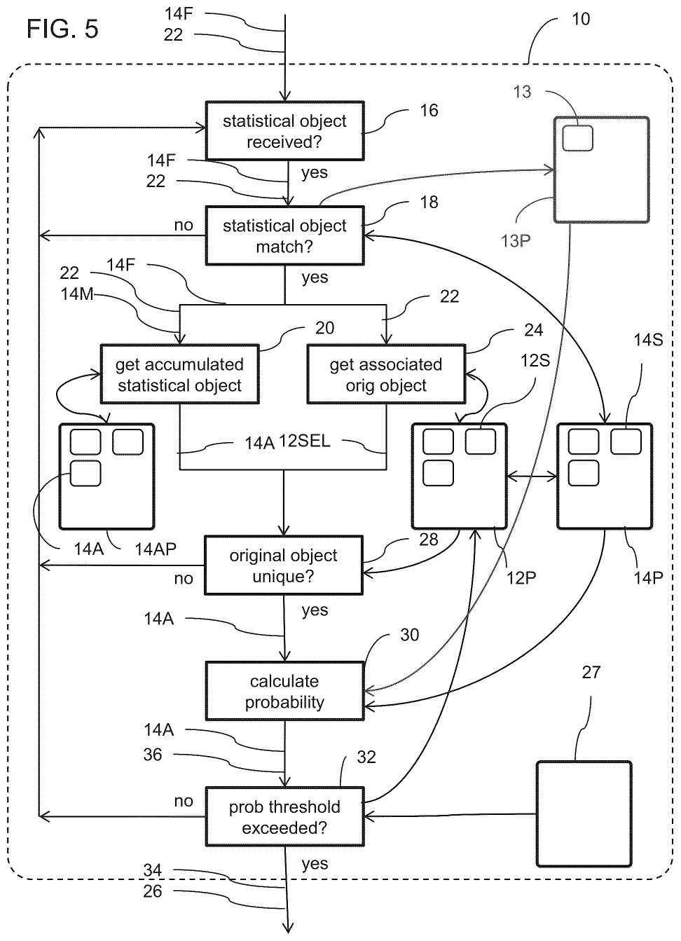

FIG. 5 shows another example embodiment including a device 10. Within the device 10, a plurality of original objects 12P is used to generate a plurality of statistical objects 14P. A communications receiver 16 may be associated with or located within the device 10 and is in signal communication with the output of the device 10 and to a statistical object matcher 18. The statistical object matcher 18 is in signal communication with an accumulated statistical object selector 20 and an associated original object selector 24, and has access to the plurality of statistical objects 14P and a plurality of attack measurements 13P. The accumulated statistical object selector 20 is in signal communication with an associated original object identifier 28 and has access to a plurality of accumulated statistical objects 14AP. An associated original object selector 26 is in signal communication with an associated original object identifier 28 and has access to a plurality of original objects 12P. The associated original object identifier 28 is in signal communication with a probability calculator 30 and has access to the plurality of statistical objects 14P. The probability calculator 30 is in signal communication with the threshold comparator 32 and has access to the plurality of statistical objects 14P and a plurality of attack measurements 13P. The probability calculator 30 is connected to the output of the device 10 and has access to a threshold probability value 27 and the plurality of original objects 12P.

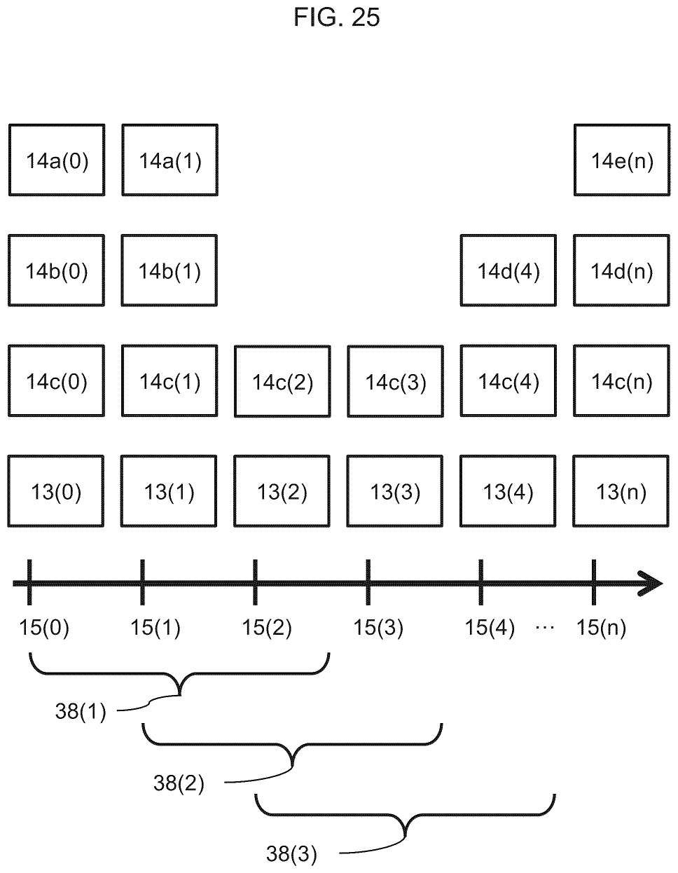

FIG. 25 shows an example of statistical objects 14S and attack measurements 13 and their relationships over time. Across the bottom, there is a timeline with multiple timestamps, timestamp 15(0) through timestamp 15(n). These timestamps are grouped into time periods 38 with time period 38(1) spanning timestamp 15(0) through timestamp 15(2), time period 38(2) spanning timestamp 15(1) through timestamp 15(3), and time period 38(3) spanning timestamp 15(2) through timestamp 15(4). Associated with timestamp 15(0) are statistical objects 14a(0), 14b(0), 14c(0), and attack measurement 13(0). Associated with timestamp 15(1) are statistical objects 14a(1), 14b(1), 14c(1), and attack measurement 13(1). Associated with timestamp 15(2) are statistical objects 14c(2), and attack measurement 13(2). Associated with timestamp 15(3) are statistical objects 14c(3), and attack measurement 13(3). Associated with timestamp 15(4) are statistical objects 14d(4), 14c(4), and attack measurement 13(4). Associated with timestamp 15(n) are statistical objects 14e(n), 14d(n), 14c(n), and attack measurement 13(n).

As explained above, the foregoing individual components of the example embodiments of the device 10 are to be understood as logical components having particular functions. The logical components are not limited to any specific configuration of physical circuitry except as would be understood by those skilled in the art as requiring specific physical components to execute the ascribed logical functions to each such logical component.

### IV. Methods for Statistical Object Identification

Having shown in general form components of a device to perform statistical object identification, example embodiments of a method for operating the device will now be explained. In one example embodiment, the device 10 contains (e.g., stores on a computer readable medium) a plurality of original objects 12P. For each original object 12S, at least one statistical object 14S is generated. Multiple statistical objects 14P may be generated from any one or more of the single original objects 12S (e.g., as a result of repeated application of a hash function on the same original object), and each corresponding statistical object 14S has a name, pointer, or other indication of the original object 12S from which it was created. The first statistical object generated from an original object 12S is referred to as a first statistical object 14F. Since multiple statistical objects 14P may be created from a single original object 12S, multiple pointers or other indications to the additional inputs to the statistical object generator (e.g., hash function) may also be provided. These additional inputs may include clock information, keying information, state information, and other relevant and useful information. The plurality of statistical objects 14P generated from the plurality of original objects 12P may be maintained and may be available within the device 10, e.g., on a computer readable medium. The plurality of statistical objects 14P may be individually or as a group, periodically removed, added to, invalidated, or otherwise refreshed. Likewise, the plurality of original objects 12P may be individually or as a group removed, added to, invalidated, or otherwise refreshed.

When a first statistical object 14F is received by the communications receiver 16, it is received within the context of a device-to-device or other digital communication and has communications characteristics 22 associated with it. These communication characteristics 22 may include, for example, the network address of the sender of the communication, the physical interface or port upon which the communication was received and the logical interface upon which the communication was received. For network communications, communications characteristics 22 may include, e.g., the IPV4 or IPV6 address of the sender, session information including local and remote addresses and local and remote port numbers, VLAN identifiers and other network, protocol stack and application information. Communications characteristics 22 may also include security association information. Physical characteristics of the communications characteristics 22 may include the frequency or frequencies that the communication was received. Physical characteristics of communications characteristics 22 may also include phase information, time information and amplitude information.

After a first statistical object 14F has been received, it is communicated to a statistical matcher 18, wherein the first statistical object 14F is compared with the plurality of statistical objects 14P. If a matching statistical object 14M is not found in the comparison, the first statistical object 14F is not identified and no further statistical object resolution activity occurs on this reception of the first statistical object 14F. As will be explained further below, if no matching statistical object is found, the device 10 makes no further statistical object resolution activity occurs on this reception of a statistical object, identifies the reception of the first statistical object 14F as an attack, makes an attack measurement 13 and adds the attack measurement 13 to the plurality of attack measurements 13P. An attack measurement 13 includes the timestamp of the attack. The timestamp of the attack is used to exclude older attack measurements 13 when they are no longer relevant. If there is at least one statistical object 14S (i.e., one or more matching statistical objects 14M) in the plurality of statistical objects 14P that matches the first statistical object 14F, then the first statistical object 14F, all matching statistical objects 14M and indicators to their respective original objects 12P, and the communications characteristics 22 are passed to an accumulated statistical object selector 20. The accumulated statistical object selector 20 takes the input communications characteristics 22 and searches for an accumulated statistical object 14A within a plurality of accumulated statistical objects 14AP that has matching communication characteristics 22. If a matching accumulated statistical object 14MA is found, the first statistical object 14F and the list of all original objects 12P associated with the matched statistical objects 14M are added to the matched accumulated statistical object 14MA. This increases the amount of statistical object information. If a matching accumulated statistical object 14MA is not found, a new accumulated statistical object 14NA is created and added to the plurality of accumulated statistical objects 14AP. The communications characteristics 22 of the accumulated statistical object 14A are copied from the communications characteristics 22, the first statistical object 14F and the list of all original objects 12P associated with the matched statistical objects 14M are added to the accumulated statistical object 14A. In both cases, the resulting accumulated statistical object 14A is passed to the original object identifier 26.

If an accumulated statistical object 14A is inactive for a predetermined period of time, the accumulated statistical object 14A may be removed from the plurality of accumulated statistical objects 14AP. An accumulated statistical object 14A may be considered inactive, for example, if it has not unambiguously identified a unique original object 12S, and first statistical objects 14FP with matching communications characteristics 22 have not been received for a predetermined period of time. An accumulated statistical object 14A may also be considered inactive if it has selected a unique original object 12S, but the accumulated statistical object 14A exceeds a probability threshold value 27, and first statistical objects 14F with matching communications characteristics 22 have not been received for a predetermined period of time.

The original object identifier 26 takes the given accumulated statistical object 14A and determines if accumulated statistical information within the accumulated statistical object 14A could only be generated by a single, unique original object 12S. This determination is made by successively removing (“pruning”) associated original objects, that as additional statistical object information is added, fail to be able to generate the stream of statistical objects that matches the received statistical objects until only a single original object 12S remains. If a unique original object 12S is not determined, the accumulated statistical object 14A is updated with the pruned list of associated original objects 12P, and no further statistical object resolution activity occurs on this particular reception of a statistical object. If a unique original object 12S is determined, it is selected by the original object identifier 26 and the selected original object 12SEL is indicated in the accumulated statistical object 14A. The accumulated statistical object 14A is then sent to a probability calculator 30. The probability calculator 30 takes the given accumulated statistical object 14A, and based on the number of bits of statistical object information that has been accumulated in the accumulated statistical object 14A, the number of statistical objects in the plurality of statistical objects 14P, and the accumulated attack measurement 13A. calculates a probability of guessing (e.g., such as by an attacker generating in some form) the accumulated statistical object 14A information. The accumulated attack measurement 13A is the sum of the plurality of attack measurements 13P. The calculated probability 36 is sent to the threshold comparator 32. The threshold comparator 32 takes the given calculated probability 36 and compares that value with the probability threshold value 27. The probability threshold value May 27 be taken from an original object 12S, may be a configurable value for the plurality of original objects 12P within, associated with or accessible to the device 10, or may be controlled by an outside entity. If the threshold comparator 32 determines that the calculated probability 36 exceeds the probability threshold value 27, no further statistical object resolution activity occurs on this reception of that particular statistical object 14S. If the threshold comparator 32 determines that the calculated probability 36 is less than the probability threshold value 27, an indication 34 is produced that includes the selected original object 26SEL. The indication 34 may also include the communications characteristics 22 and any other available information required by the receipt of the indication 34. Other information may include the calculated probability 36, the probability threshold value 27, the time that the corresponding first statistical object 14F was received, or other information, states, statistics, and associated information. The indication may also contain additional inputs to the statistical object generator, which may be provided by pointer from a statistical object 14S. These additional inputs may include clock information, keying information, state information, and other relevant and useful information.

By utilizing a probability threshold value 27, a threshold comparator 32 and calculating, in real time, the present probability of guessing an accumulated statistical object 14A based on the number of statistical objects present in the plurality of statistical objects 14P, the probability of guessing an accumulated statistical object 14A is held constant while the number of statistical objects present in the plurality of statistical objects 14P can vary. Likewise, the probability of guessing a first statistical object 14F is also held constant. It should be noted that the probability threshold value 27 can be changed at any time. A change in the probability threshold value 27 does not require communication or coordination with the generator (e.g., remote device operated by a user) of the first statistical object 14F. Because of this, the probability threshold value 27 can be adjusted, and the system for statistical object identification will not provide any response until the threshold value has been met. This effectively allows the statistical object identification system to increase or decrease the probability threshold value 27 without providing any detectable indication of the change in the probability threshold value 27.

In another embodiment, a device 10 contains a plurality of original objects 12P. For each original object 12S, at least one statistical object 14 is generated. Multiple statistical objects 14 may be generated from a single original object 12S and each statistical object 14 contains a name, pointer or other indication of the original object 12S from which it was created. The first statistical object generated from an original object 12S is referred to as a first statistical object 14F. The plurality of statistical objects 14P generated from the plurality of original objects 14P is maintained and is available within the device 10. The plurality of statistical objects 14P may be individually or as a group periodically removed, added to, invalidated or otherwise refreshed. Likewise, any one or more of the plurality of original objects 12P may be individually or as a group removed, added to, invalidated or otherwise refreshed.

When a first statistical object 14S is received by a communications receiver 16, it is received within the context of a communication and has communications characteristics 22 associated with it. After a first statistical object 14F has been received, using a statistical matcher 18, the first statistical object 14F is compared against the plurality of statistical objects 14P. If a matching statistical object 14M is not found, the first statistical object 14F is not identified and no further statistical object resolution activity occurs on this reception of a statistical object, identifies the reception of the first statistical object 14F as an attack, makes an attack measurement 13 and adds the attack measurement 13 to the plurality of attack measurements 13P. An attack measurement 13 includes the timestamp of the attack. The timestamp of the attack is used to exclude older attack measurements 13 when they are no longer relevant. If there is at least one statistical object 14S in the plurality of statistical objects 14P that matches the first statistical object 14F, the first statistical object 14F, all matching statistical objects 14P and indicators to their respective original objects 12P and the communications characteristics 22 are passed to an accumulated statistical object selector 20. The communications characteristics 22 are also communicated to an associated original object selector 28.

The accumulated statistical object selector 20 takes the input communications characteristics 22 and looks for an accumulated statistical object 14A within the plurality of accumulated statistical objects 14AP that has matching communication characteristics 22. If a matching accumulated statistical object 14MA is found, the first statistical object 14F and the list all original objects 12P associated with a corresponding matched statistical object 14M are added to the matched accumulated statistical object 14MA. This increases the amount of statistical object information. If a matching accumulated statistical object 14MA is not found, a new accumulated statistical object 14N is created and added to the plurality of accumulated statistical objects 14AP. The communications characteristics 22 of the accumulated statistical object 14A are copied from the communications characteristics 22, and the first statistical object 14F and the list of all original objects 12P associated with the matched statistical objects 14M are added to the accumulated statistical object 14A. In both cases, the resulting accumulated statistical object 14A is passed to the associated original object identifier 28

The associated original object selector 24 takes the input communications characteristics 22 and looks for an original object 12S within the plurality of original objects 12P that has matching communications characteristics. If a matching original object 12M is found, that original object is selected, becoming a selected original object 12S and is passed to the associated original object identifier 28. If there is no matching original object 12M, then nothing is passed to the associated original object identifier 28. If an original object 12S is inactive for a period of time, the association with communications characteristics 22 may be removed from the original object 16. An original object 12S may be considered inactive if first statistical objects 14F with matching communications characteristics 22 have not been received for a period of time. An original object 12S may also be considered inactive if first statistical objects 14F produced by the associated original object 12S have not been received for a period of time.

The associated original object identifier 28 takes the given accumulated statistical object 22 and the selected original object 12SEL and determines if the accumulated statistical information within the accumulated statistical object 14A could have been produced by the selected original object 12SEL. If the information contained within the accumulated statistical object 14A could have been generated by the selected original object 12SEL, the selected original object 12SEL is indicated in the accumulated statistical object 22 and the accumulated statistical object 14A is sent to the probability calculator 30. If the information contained within the accumulated statistical object 14A could not have been produced by the selected original object 12SEL, the selected original object 12SEL is discarded and the following processing occurs.

The associated original object identifier 28 takes the given accumulated statistical object 14A and determines if the accumulated statistical information within the accumulated statistical object 14A could only be generated by a single, unique original object 12S. This determination is made by successively pruning associated original objects that, as additional statistical object information is added, fail to be able to generate the stream of statistical objects that matches the received statistical objects until only a single original object remains. If a unique original object 12S is not determined, the accumulated statistical object 14A is updated with the pruned list of associated original objects 12P and no further statistical object resolution activity occurs on this reception of a statistical object. If a unique original object 12S is determined, the selected original object 12SEL is indicated in the accumulated statistical object 14A and the accumulated statistical object 14A is sent to the probability calculator 30. The probability calculator 30 takes the given accumulated statistical object 14A and based on the number of bits of statistical object information that has been accumulated in the accumulated statistical object 14A, the number of statistical objects 14 in the plurality of statistical objects 12P that have matching communications characteristics 22 and the accumulated attack measurement 13A. calculates a probability of guessing (e.g., such as by an attacker generating in some form a large number of statistical objects) the accumulated statistical object 14A information. The accumulated attack measurement 13A is the sum of the plurality of attack measurements 13P. The calculated probability 36 is sent to the threshold comparator 32. The threshold comparator 32 takes the given calculated probability 36 and compares that value with the probability threshold value 27. The probability threshold value 27 may be taken from an original object 12S, may be a configurable value for the plurality of original objects 12P within device 10 or may be controlled by an outside entity. If the threshold comparator 32 determines that the calculated probability 36 is greater than the probability threshold value 27, no further statistical object resolution activity occurs on this reception of a statistical object. If the threshold comparator 32 determines that the calculated probability 36 is less than the probability threshold value 27, an indication 34 is produced that includes the selected original object 12SEL and an association is made within the plurality of original objects 12P between the selected original object 12SEL and the communications characteristics 22. The indication 34 may also include the communications characteristics 22 and any other available information required by the received of the indication 34. The association between an original object 12S and communications characteristics 22 can also be created prior to receiving a first statistical object 14F. This allows the system to be pre-populated with associations that should accelerate the selection of original objects 12S and facilitate staying beneath the probability threshold value 27.

In addition to the example embodiments described above, there are a number of additional processes that may be used to assist the example described processes. As the primary mechanism for accumulating information between related statistical objects is driven by the reception of those statistical objects, it is therefore necessary to consider how to handle a partially identified statistical object which is then orphaned. An orphaned partially identified statistical object is an aggregate statistical object that has not been fully identified or has exceeded the probability threshold when the reception of matching communications characteristics ceases, thereby preventing further progress. For this case, each accumulated statistical object 14A should have a timestamp or similar aging construct that will enable the system to periodically age out idle, orphaned and otherwise unused statistical and original objects. This includes the removal of communication characteristics 22 that have been associated with original objects 12P after matching communications have been idle for a period of time.

As the communications of statistical objects is usually performed when the secured transport of an original object cannot be accomplished, it is therefore important that the security and integrity be taken into account in any implementation. To ensure that a statistical object cannot be intercepted during transmission and used by the interceptor, once a statistical object 14S matched from the plurality of statistical objects 14P, then that statistical object 14S should be invalidated and the device 10 should generate a new, different statistical object 14S from the same original object 12S. To further protect against attack, each statistical object 14S should also expire after a period of time if that statistical object 14S has not been matched and subsequently invalidated.

In one embodiment, statistical objects 14S expire in groups where the group is defined by a period of time. For instance, if statistical objects 14S have lifespan of 4 seconds, then every four second, the plurality of statistical objects 14P is allowed to expire (i.e., is purged).

In one embodiment, the device 10 may keep a window of multiple statistical object time periods to address clock drift and clock skew between physically separate communication components. For example, if statistical objects 14S have a lifespan of 4 seconds, and the device 10 maintains a window of 3 periods for a total of 12 seconds, then every 4 seconds, a portion of the plurality of statistical objects 14P are timed out and removed from the plurality of statistical objects 14P.

In one embodiment, the device 10 also maintains the plurality of attack measurements 13P, where the timestamps of the attack measurements are congruent with the lifespan of the statistical objects 14S. When the device 10 times out statistical objects 14S as described above, it also times out attack measurements 13 with timestamps within the expiration time of the timed out statistical objects 14S. In FIG. 25, when time period 38(2) starts, the statistical objects 14S and the attack measurements 13 that are older than time period 38(2) are timed out. In FIG. 25, time advances to the right and the oldest entries are on the left. Thus, when time period 38(2) begins, statistical objects 14a(0), 14b(0), 14c(0), and attack measurement 13(0) are timed out and removed from their respective plurality of statistical objects 14P and plurality of attack measurements 13P.

The association of communications characteristics 22 is usually performed after the successful identification of an original object 12S and after the calculated probability 36 is determined to be less than the probability threshold value 27. It is also possible to pre-assign communications characteristics 22 to original objects 12P. This will decrease the amount of statistical object 14S information necessary to identify the associated original object 12S. Unlike dynamically associated communication characteristics, pre-assigned associations should not expire after periods of inactivity.

The foregoing method of statistical object identification allows the system to maintain a constant probability threshold, regardless of the number of statistical objects that are contained within the plurality of statistical objects. This is accomplished by always calculating the probability of guessing the information contained in the accumulated statistical object with respect to both the number of statistical objects that are contained within the plurality of statistical objects and the accumulated statistical object information. As the number of statistical objects in the plurality of statistical objects increases, the probability of guessing increases while as the amount of statistical object information accumulates, the probability of guessing decreases. By comparing the result of the probability calculation against the probability threshold after each reception of a statistical object that results in an identified original object, adherence to the probability threshold is enforced.

The foregoing method of statistical object identity is designed to specifically enable the changing of the probability threshold and not require that the changed probability threshold be coordinated or otherwise communicated with the entities that are generating and sending the statistical objects. By not requiring any coordination or communication when changing the probability threshold 27, the device 10 can change the probability threshold 27 in response to other external factors such as the threat or presence of attack or other security or integrity event.

### V. Apparatus for Statistical Object Identification

The apparatus that performs statistical object identification may be varied and diverse. It ranges from a simple, single function device that receives statistical objects via a network or other communications medium, and identifies the original object. Once the identification is made, the communication may be forwarded to its intended destination. Before identification is made, no communications are allowed to pass across the device. It is expected that in many cases, the apparatus will be a module or subsystem within a larger system. This module may take the form of a state machine in an application specific integrated circuit (ASIC) or other form of integrated circuit or semiconductor implementation. This module may also take the form of logic coding provided to a programmable logic device such as a field programmable gate array (FPGA), programmable array logic (PAL) and other forms of programmable logic. This module may also take the form of instructions for a microprocessor. The module may also take the form of instructions to a synthetic or virtual processor or machine.

The apparatus that performs statistical object identification may be used in communications devices, security devices, network routing devices, application routing devices, service delivery devices and other devices that are enabled by the addition of the efficient communication of an original object through the reception of a statistical object which is identified as being generated from an original object.

### VI. Examples

One specific, simplified example according to the present disclosure is described below. The following example offers a description of:
1. an original object 12S;
2. how that original object 12S is transformed into a statistical object 14S; and
3. how that statistical object 14S is identified as having been generated by the original object 12S.

The numbering convention that is used in this Specification, the Drawings, and the Claims to identify original and statistical objects is presented in Table 1

### Table 1

10 Device (In this example, the Remote System)
12M Matched Original Object
12P Plurality of Original Objects
12S Original Object
12SEL Selected Original Object
14A Accumulated Statistical Object
14AP Plurality of Accumulated Statistical Objects
14F First Statistical Object
14N New Statistical Object
14S Statistical Object

The letter “S” is used to identify a single object, while the letter “P” is used to represent a plurality of objects. The reference character that refers to an original object includes the numeral “12”, while the numeral “14” is used to refer to a statistical object.

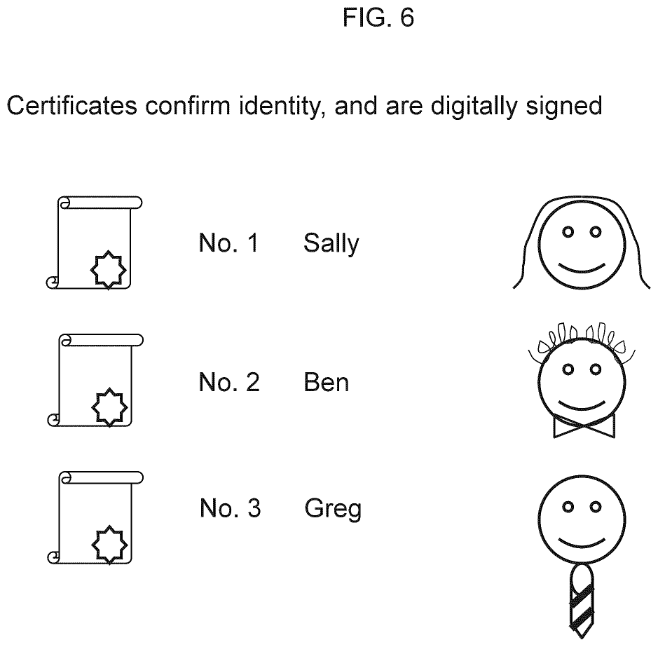

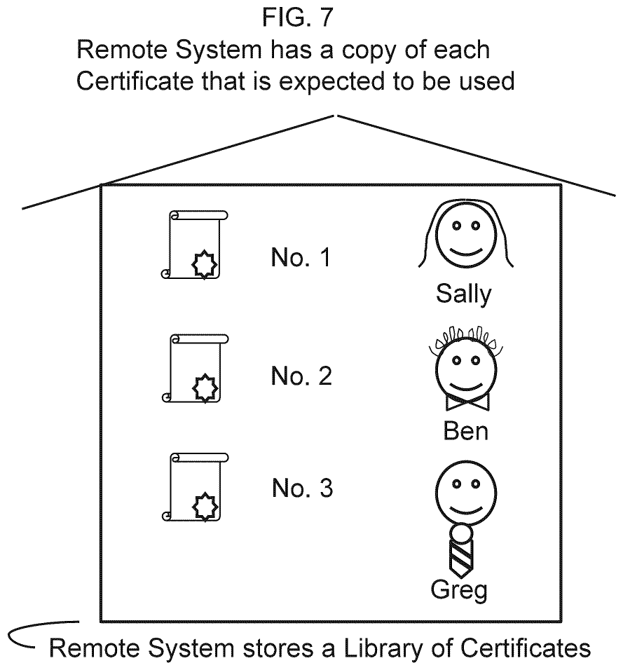

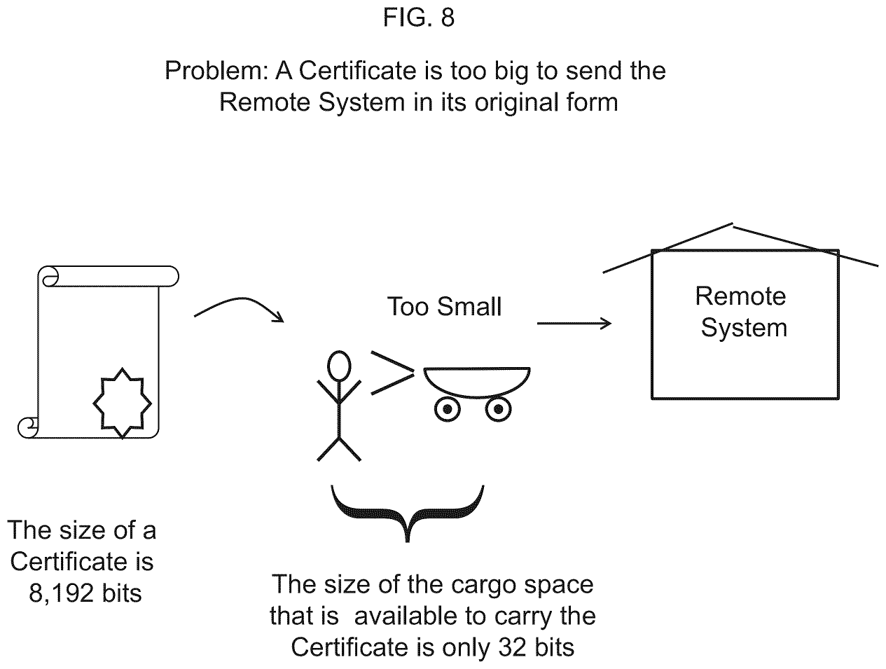

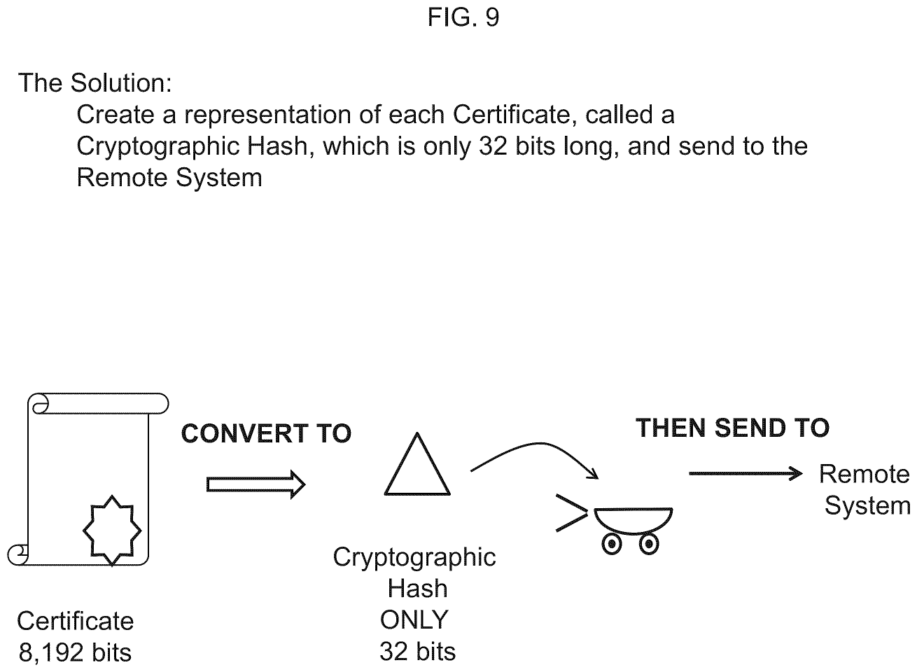

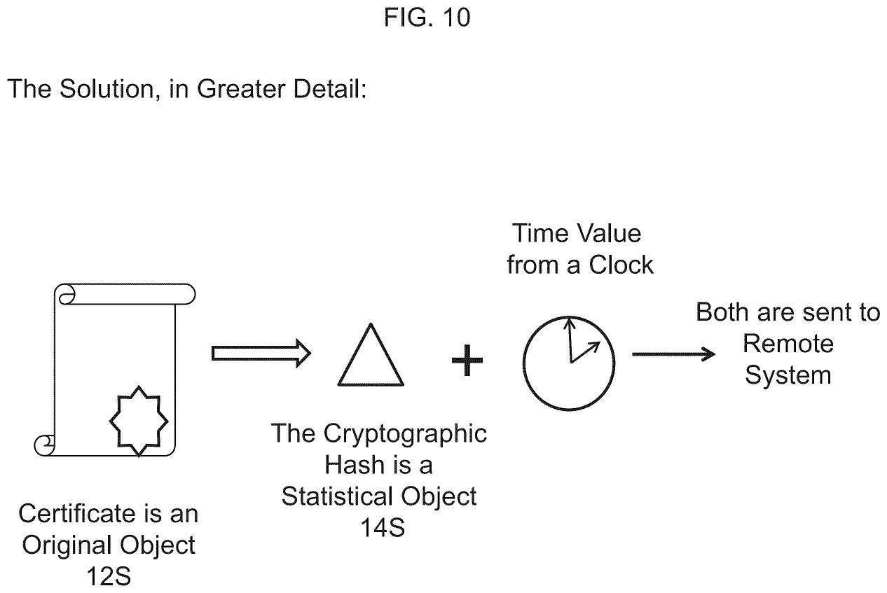

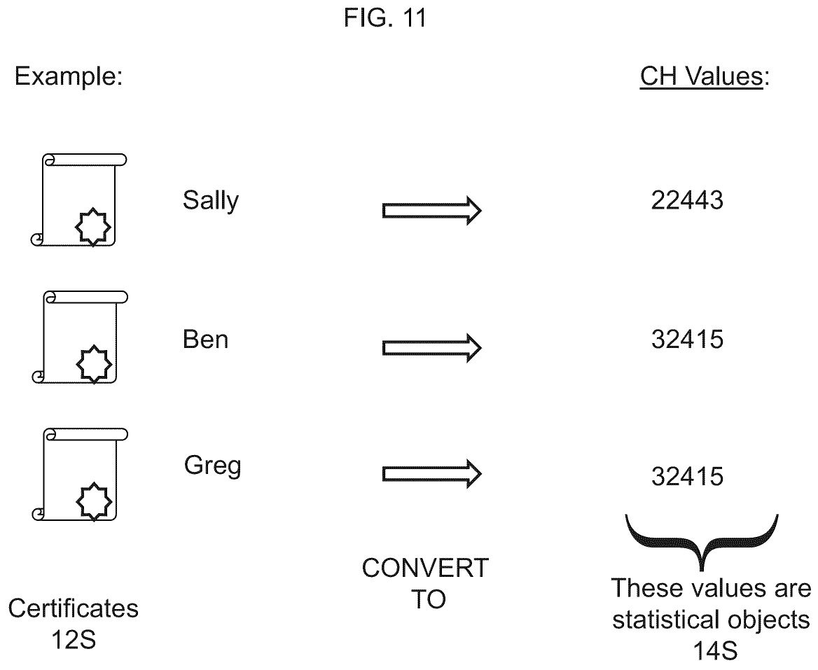

For the foregoing examples, an original object 12S may be an X.509 certificate. An X.509 certificate is used to provide identity and is digitally signed to prove its authenticity. For this example, the X.509 certificates are 1 KB in size (1024 bytes, 8192 bits). It is necessary to communicate that a specific X.509 certificate is being used to a remote system that has a copy of each X.509 certificate that is expected to be used. In the present example, the system had been designed before there was a requirement to communicate the X.509 certificates, and there is only enough space to communicate 32 bits of information, certainly not enough to send an entire X.509 certificate, which is 256 times larger. But still needing to communicate the X.509 certificate, a cryptographic hash, 32 bits in length, is generated for each X.509 certificate and a common clock. The cryptographic hash is a statistical object 14S generated from an original object 12S. Now let us assume that we have 100 of these X.509 certificates, that is 100 original objects 12S. And let us assume that for each original object 12S, we generate a cryptographic hash of each X.509 certificate and a common clock to produce 100 statistical objects 14S each 32 bits in length. For descriptive purposes, three of these X.509 certificates and their corresponding statistical objects are described in FIG. 6. X.509 certificate #1 identifies Sally and generates a statistical object 14S of value 22443. X.509 certificate #2 identifies Ben and generates a statistical object 14S of value 32415. X.509 certificate #3 identifies Greg. FIG. 7 shows those original objects 12P present on the remote system. FIG. 8 shows that the communications system cannot fit the certificate to communicate it to the remote system. FIG. 9 shows how sending a hash that is much, much smaller than the original certificate can be communicated to the remote system. FIG. 10 shows the generation of the statistical object in greater detail. FIG. 11 shows the statistical object 14S generation from each of the original objects 12S. The statistical object 14S for Greg has a value of 32415. The device 10 has generated the plurality of statistical objects 14P corresponding to the plurality of original objects 12P.

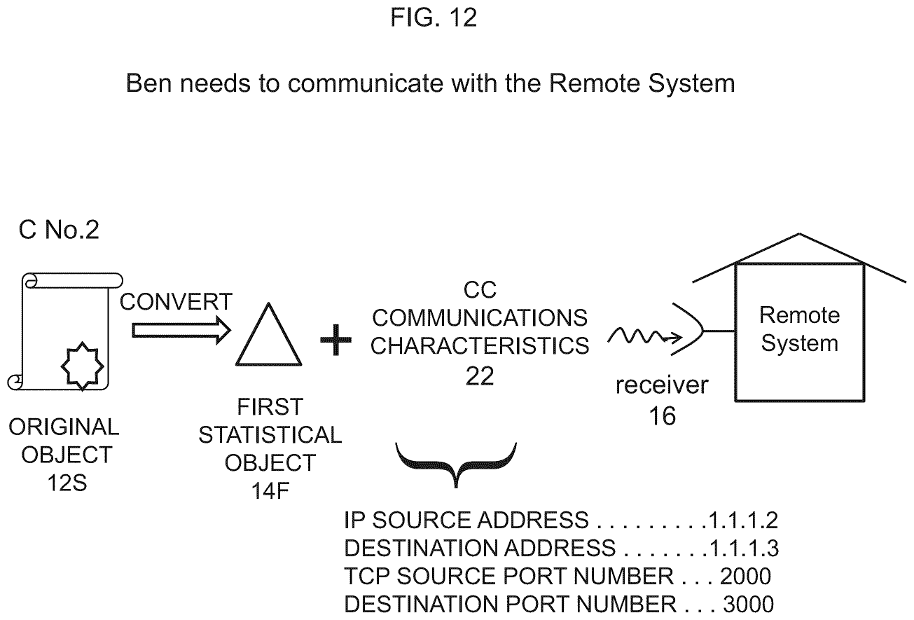

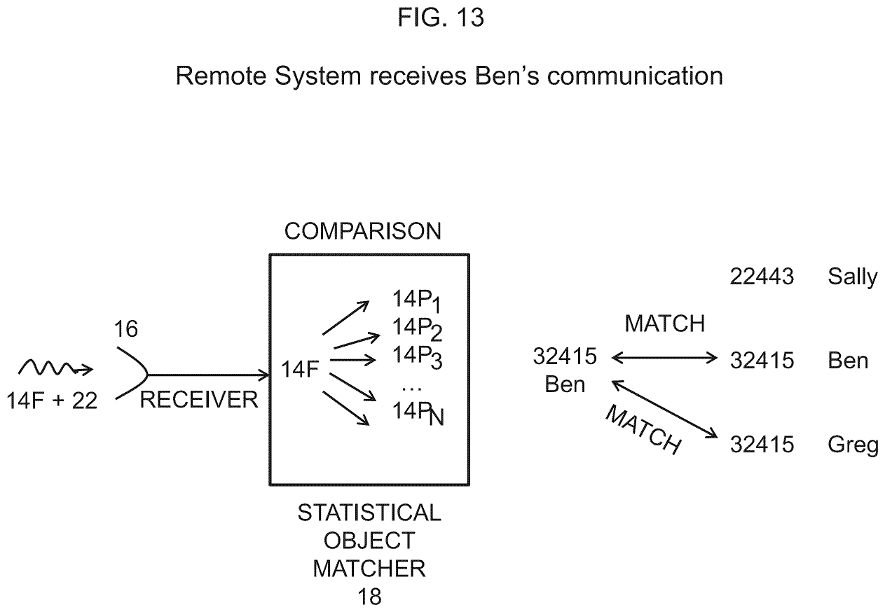

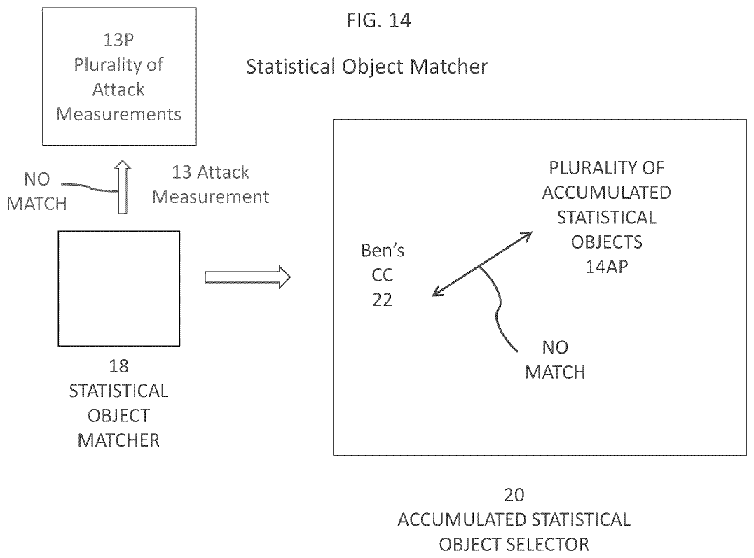

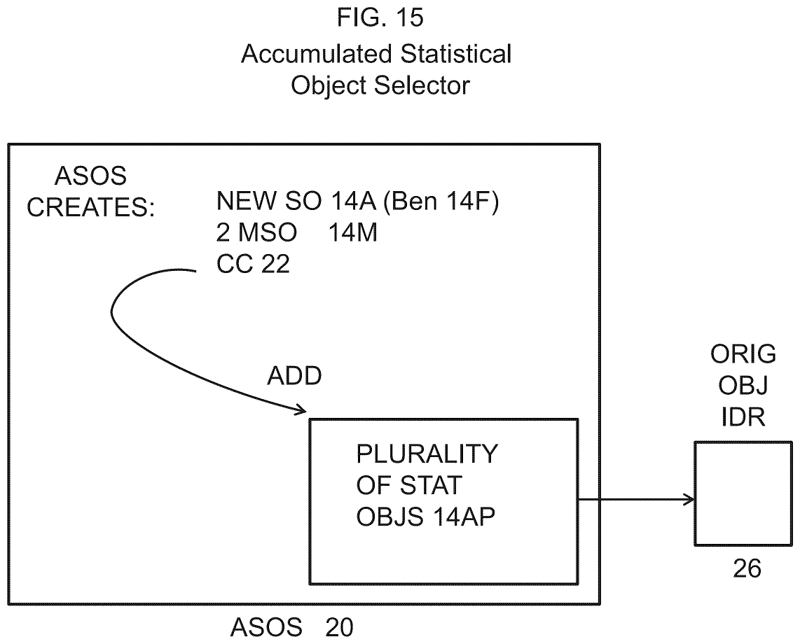

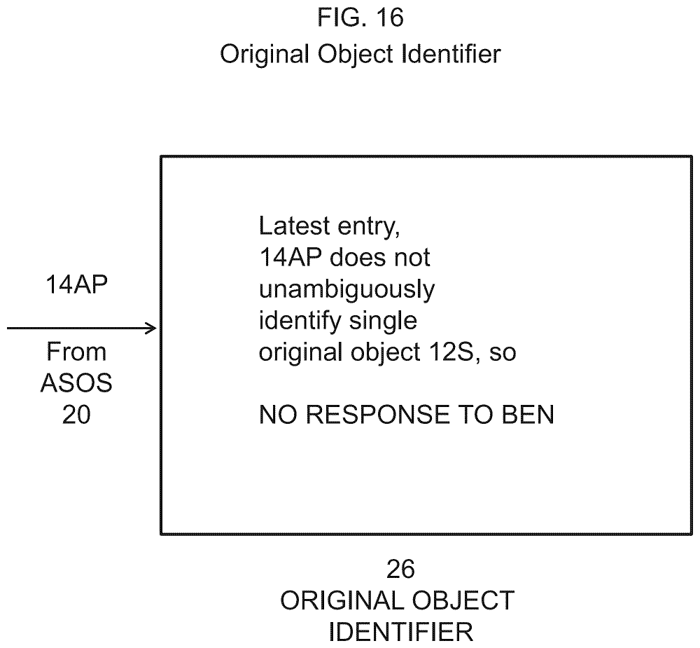

Now Ben needs to send a communication containing Ben's statistical object to device 10. Device 10 receives Ben's communication using a communications receiver 16. Although we, the narrator, knows that it was Ben that sent the communication to device 10, device 10 does not know this. Ben's communication includes Ben's statistical object (first statistical object 14F) and communications characteristics 22. In this case, the communications occurred over a TCP/IP network and the IP source and destination addresses and the TCP source and destination port numbers are used as communications characteristics 22. The source IP address is 1.1.1.2 and the destination IP address is 1.1.1.3. The source TCP port number is 2000 and the destination TCP port number is 3000. This is shown in FIG. 12. The communications receiver 16 sends the received communications characteristics 22 and Ben's statistical object 14F to the statistical object matcher 18. The statistical object matcher 18 compares Ben's statistical object 14F with the plurality of statistical objects 14P, and determines that there it matches two statistical objects, Ben's, and Greg's. This is shown in FIG. 13. The statistical object matcher 18 sends Ben's statistical object 14F, the two matched statistical objects 14M (Ben's and Greg's) and the communications characteristics 22 to the accumulated statistical object selector 20. If the first statistical object 14F received by the statistical object matcher 18 had not matched any of the plurality of statistical objects 14P, then the statistical object matcher 18 would consider the reception of the first statistical object 14F an attack, and add an attack measurement 13 with the current time in a timestamp 15 to the plurality of attack measurements 13P. The accumulated statistical object selector 20 compares Ben's communications characteristics 22 with the plurality of accumulated statistical objects 14AP and finds no matches. This is shown in FIG. 14. Because no matches were found, the accumulated statistical object selector 20 creates a new accumulated statistical object 14A including Ben's statistical object 14F, the two matched statistical objects 14M and the communications characteristics 22. This is shown in FIG. 15. The new accumulated statistical object 14A is added to the plurality of accumulated statistical objects 14AP. The accumulated statistical object information is set to 32 bits to reflect the information contained in statistical object 14F. The accumulated statistical object 14AP is passed to the original object identifier 26. The original object identifier 26 determines that the accumulated statistical object 14AP does not unambiguously identify a single original object 12S. This is shown in FIG. 16. This concludes the operation of the device 10 for the reception of Ben's statistical object. The device 10 does not respond to Ben's communication because it cannot unambiguously determine who sent the communication.

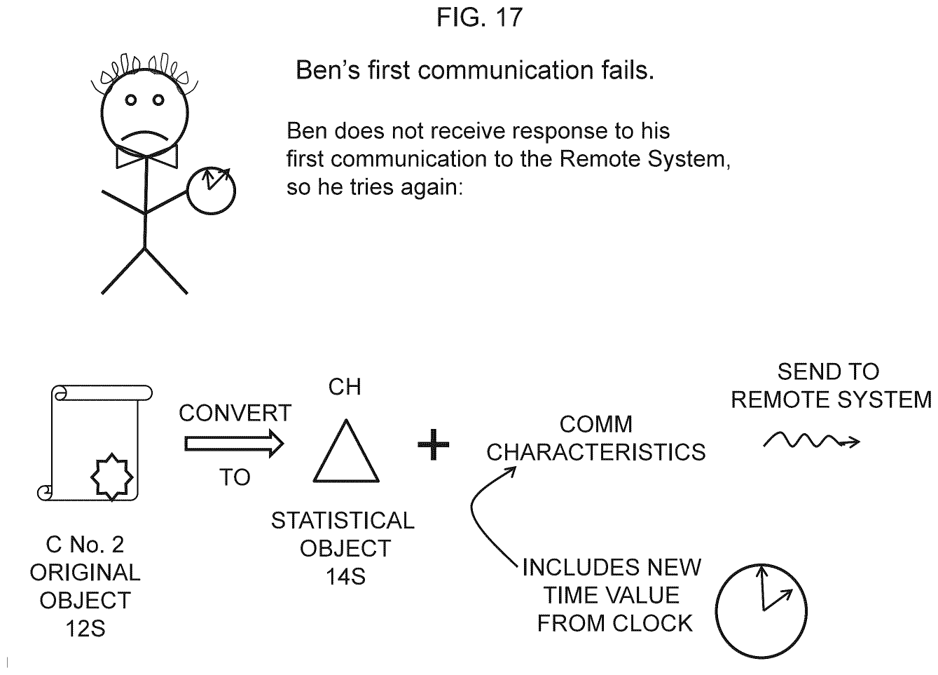

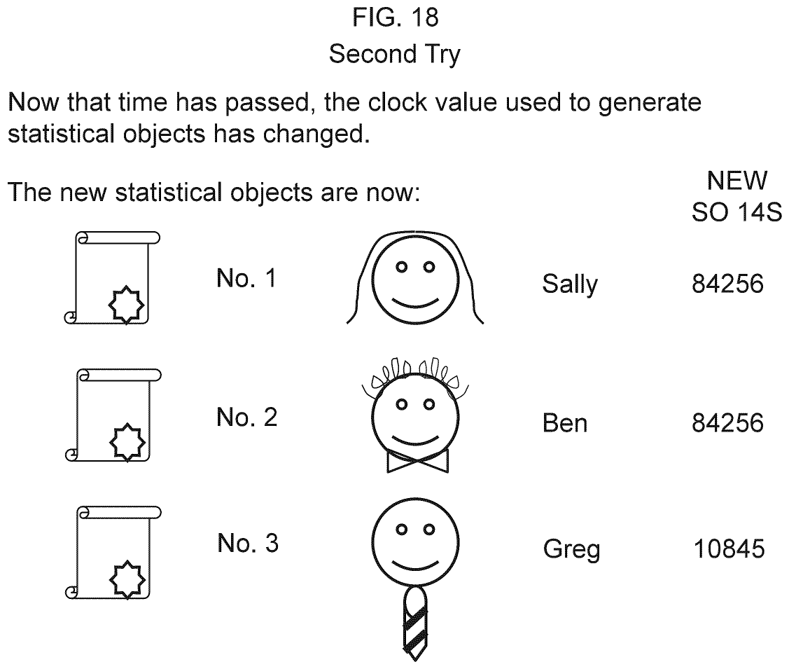

Now Ben, who sent the original communication did not receive a response, so he sends another communication. This is shown in FIG. 17. Since time has passed since the first communication attempt, the clock value used to generate the statistical objects has changed. The new statistical objects and their corresponding X.509 certificates are: X.509 certificate #1 identifies Sally and generates a statistical object 14S of value 84256. X.509 certificate #2 identifies Ben and generates a statistical object 14S of value 84256. X.509 certificate #3 identifies Greg and generates a statistical object 14S of value 10845. Due to time passing, device 10 regenerates the plurality of statistical objects 14P corresponding to the plurality of original objects 12P which match Sally, Ben, and Greg. This is shown in FIG. 18.

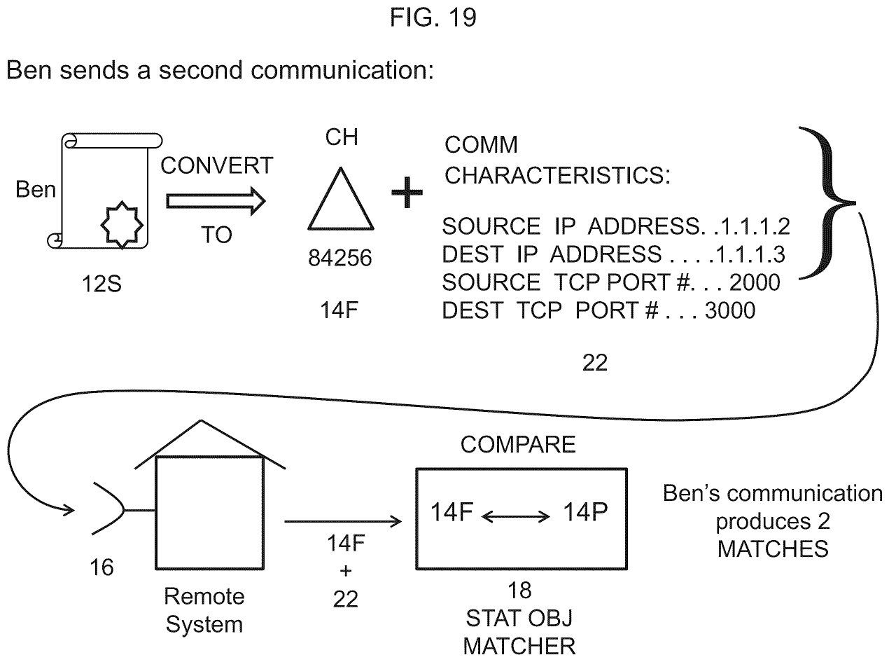

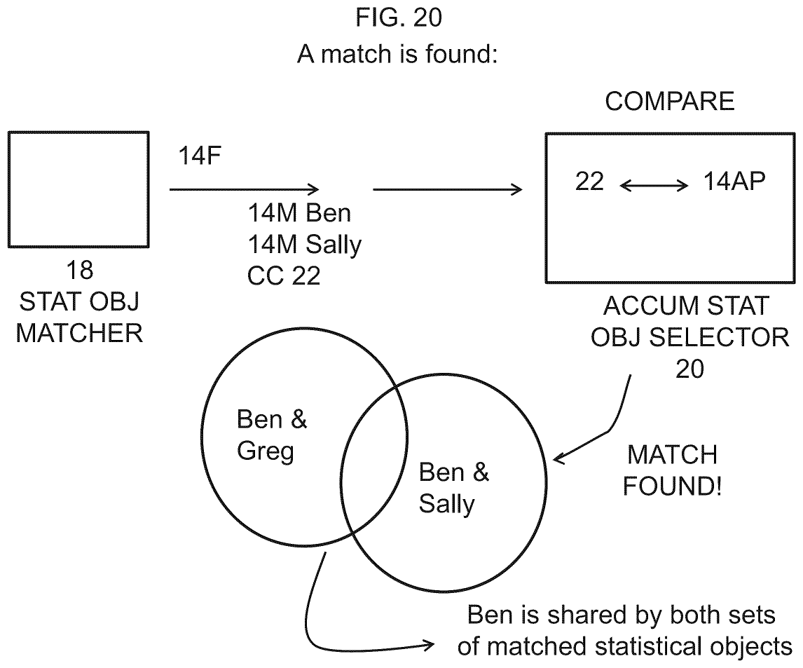

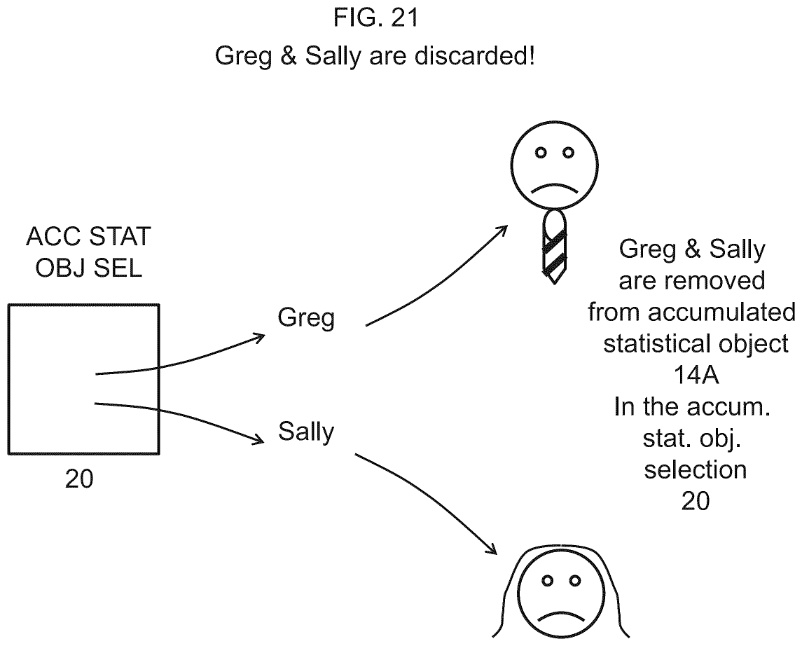

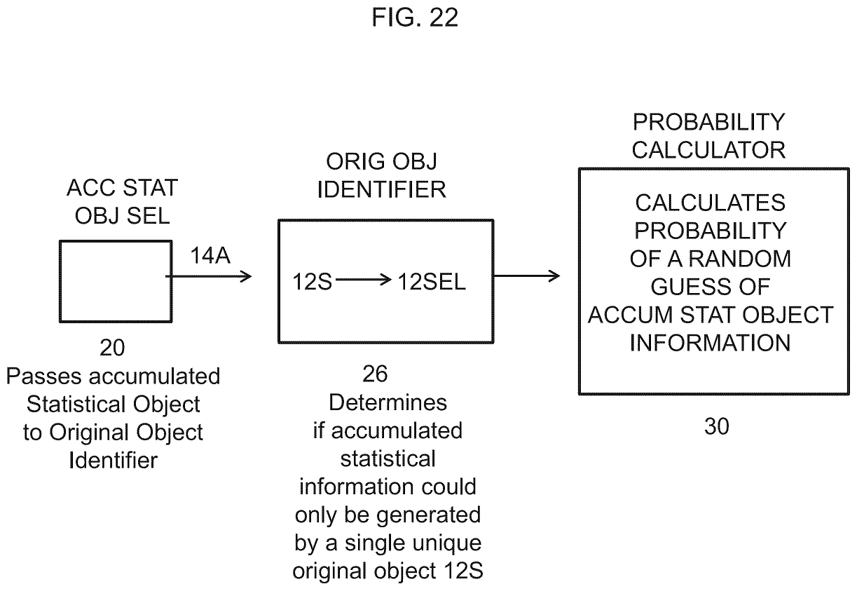

Now Ben sends a second communication containing Ben's current statistical object to device 10. Device 10 receives Ben's communication using a communications receiver 16. Ben's communication includes Ben's statistical object 14F and communications characteristics 22. Again, the communications characteristic 22 is source IP address of 1.1.1.2, destination IP address of 1.1.1.3, source TCP port number of 2000 and destination TCP port number of 3000. This is shown in FIG. 19. The communications receiver 16 sends the received communications characteristics 22 and Ben's statistical object 14F to the statistical object matcher 18. The statistical object matcher 18 compares Ben's statistical object 14F with the plurality of statistical objects 14P and determines that there it matches two statistical objects, Ben's, and Sally's. The statistical object matcher 18 sends Ben's statistical object 14F, the two matched statistical objects 14M (Ben's and Sally's) and the communications characteristics 22 to the accumulated statistical object selector 20. The accumulated statistical object selector 20 compares Ben's communications characteristics 22 with the plurality of accumulated statistical objects 14AP and finds a match with Ben's previous communication. The matched accumulated statistical object 14A includes the previous matched statistical object 14M containing Ben and Greg and is compared against the two matched statistical objects 14M matching Ben's statistical object 14F containing Ben and Sally. The intersection of both matched statistical sets is Ben. This is shown in FIG. 20. Greg and Sally are removed from the accumulated statistical object 14A as shown in FIG. 21. The accumulated statistical object information increases from 32 bits to 64 bits with the addition of statistical object 14F. The accumulated statistical object 14A is passed to the original object identifier 26. The original object identifier 26 takes the given accumulated statistical object 14A and determines if the accumulated statistical information within the accumulated statistical object could only be generated by a single, unique original object 12S. Original object 12S is Ben's X.509 certificate. Original object 12S is now indicated as selected original object 12SEL and is passed to the probability calculator 30. This is shown in FIG. 22. The probability calculator 30 takes the given accumulated statistical object 14A, and, based on the number of bits of statistical object information that has been accumulated in the accumulated statistical object 14A, the number of statistical objects in the plurality of statistical objects 14P, and the accumulated attack measurement 13A. calculates a probability of guessing the accumulated statistical object 14A information. The accumulated attack measurement 13A is the sum of the plurality of attack measurements 13P.

In this example, there are 60 statistical objects 14S, an accumulated attack measurement 13A of 40 and the device 10 has received 64 bits of statistical object information (32 bits×2). The number of statistical objects 14S and the accumulated attack measurement 13A are added together, resulting in 100. The probability of guessing is calculated by using the formula: p(n;d)≈1−e⁻ⁿ^{²}^{/(2×d)}, where n is the number of statistical objects in the table of valid statistical objects; d is the total number of unique statistical objects available; and d is d=2^{b} where b is the number of bits of statistical object information received. Therefore: d=2⁶⁴, n=100 resulting in

$$p ( 100 , {2}^{64} ) \approx 1 - {e}^{- 10 {0}^{2} / ( 2 \times {2}^{64} )} ,$$

$$p ( 10 \; 0 , {2}^{64} ) \approx 0.$$

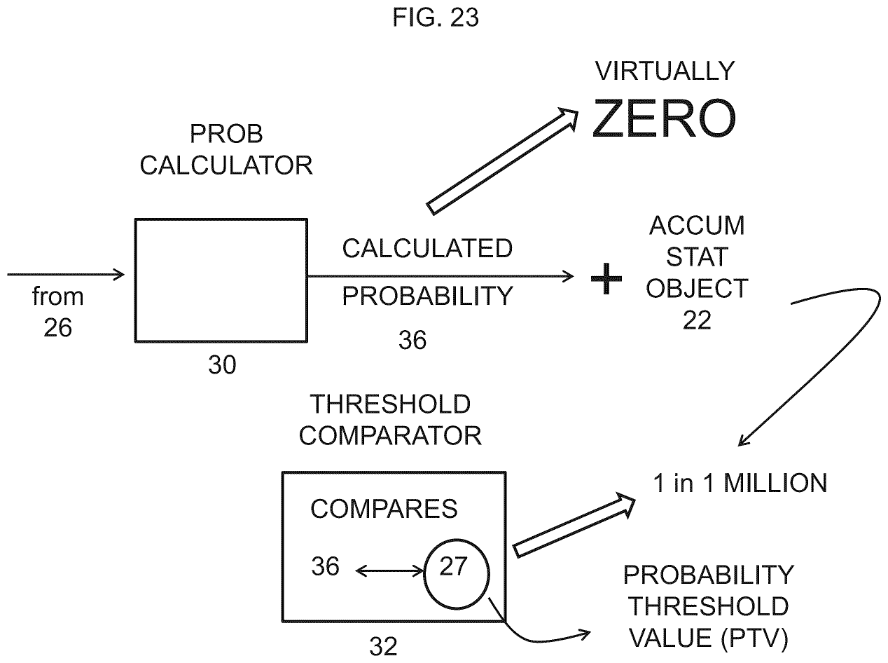

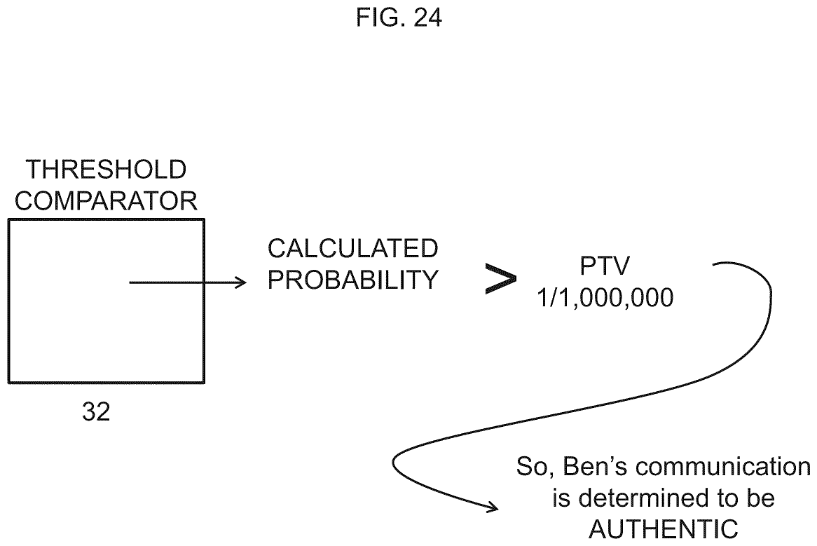

In this case, with only a few original objects (60), relatively few attacks (4), and a relatively large amount of accumulated statistical object information, the probability of guessing those 64 bits of accumulated statistical object information is vanishingly small, approaching zero. This calculated probability 36 and the accumulated statistical object 22 are passed to the threshold comparator 32. The threshold comparator 32 takes the calculated probability 36 and compares it with the probability threshold value 27. In our example, the probability threshold value 27 is 1 in a million. The threshold comparator 32 determines that our calculated probability 27 of zero is less than the probability threshold value of 1 in a million. This is shown in FIG. 23. Having not exceeded our probability threshold value 27, the threshold comparator 32 makes an indication 30 that includes the selected original object 12SEL Ben. This indication 30 communicates to other functions within the device 10 that the communication was send by Ben and has not exceeded the probability threshold value 27, and that the device 10 should now respond to Ben's communication. This is shown in FIG. 24.

In a second example, we continue with the first example but change the number of statistical objects 14S from 60 to 99,000,000 (ninety nine million), and the number of accumulated attack measurement 13A to 1,000,00 (one million) for a total of 100,000,000 (one hundred million) used in our probability calculation. The calculated probability 36 of guessing the accumulated statistical object 14A with 64 bits of information is 2.674%, greater than the probability threshold value of 1 in a million. Since this is greater than the threshold, this concludes the operation of the device 10 for the reception of Ben's statistical object. The device 10 does not respond to Ben's communication because it has exceeded the probability threshold value 27. Now Ben, who sent the original communications again did not receive a response, so he sends another communication. Device 10 receives Ben's communication using a communications receiver 16. Ben's communication includes Ben's statistical object 14F and communications characteristics 22. Again, the communications characteristic 22 is source IP address of 1.1.1.2, destination IP address of 1.1.1.3, source TCP port number of 2000 and destination TCP port number of 3000. The communications receiver 16 sends the received communications characteristics 22 and Ben's statistical object 14F to the statistical object matcher 18. The statistical object matcher 18 compares Ben's statistical object 14F with the plurality of statistical objects 14P and determines that there it matches only a single statistical object, Ben's. The statistical object matcher 18 sends Ben's statistical object 14F, the matched statistical object 14M (Ben's) and the communications characteristics 22 to the accumulated statistical object selector 20. The accumulated statistical object selector 20 compares Ben's communications characteristics 22 with the plurality of accumulated statistical objects 14AP and finds a match with Ben's previous communication. The matched accumulated statistical object 14A includes the previous matched statistical object 14M containing only Ben and is compared against the matched statistical object 14M matching Ben's statistical object 14F containing Ben. The intersection of both matched statistical sets is Ben. The accumulated statistical object information increases from 64 bits to 96 bits with the addition of statistical object 14F. The accumulated statistical object 14A is passed to the original object identifier 26. The original object identifier 26 takes the given accumulated statistical object 14A and determines if the accumulated statistical information within the accumulated statistical object could only be generated by a single, unique original object 12S. Original object 12S is Ben's X.509 certificate. Original object 12S is now indicated as selected original object 12SEL and is passed to the probability calculator 30. The probability calculator 30 takes the given accumulated statistical object 22, and, based on the number of bits of statistical object information that has been accumulated in the accumulated statistical object 22 and the number of statistical objects in the plurality of statistical objects 14P, calculates the probability of guessing the accumulated statistical object information. In a second example, we continue with the first example but change the number of original objects 12S from 60 to 99,000,000 (ninety million) and the number of accumulated attack measurement 13A to 1,000,000 (one million) for a total of 100,000,000 (one hundred million) used in this example probability calculation. The calculated probability 36 of guessing the accumulated statistical object 14A with 96 bits of information is again vanishingly small, approaching zero. This calculated probability 36 and the accumulated statistical object 22 are passed to the threshold comparator 32. The threshold comparator 32 takes the calculated probability 36 and compares it with the probability threshold value 27. The threshold comparator 32 determines that our calculated probability 27 of 0 is less than the probability threshold value of 1 in a million. Having not exceeded our probability threshold value 27, the threshold comparator 32 makes an indication 30 that includes the selected original object 12SEL Ben. This indication 30 communicates to other functions within the device 10 that the communication was send by Ben and has not exceeded the probability threshold value 27 and that the device 10 should now respond to Ben's communication. This shows how Ben can communicate, even while the system is under attack, without resorting to blocking communication from devices with communications characteristics 22 in common with the attacks.

In a third example may continue from the second example and add an association of the selected original object 12SEL (Ben) and the communications characteristics 22. This allows for the optimization of subsequence communication requests from Ben.

Continuing with the third example, Ben makes another communication to device 10 during which within device 10 an association exists between Ben's original object and the communications characteristics 22 of Ben's previous communication. Device 10 receives Ben's communication using a communications receiver 16. Ben's communication includes Ben's statistical object (first statistical object 14F) and communications characteristics 22. This time, the communications characteristics 22 is source IP address of 1.1.1.2, destination IP address of 1.1.1.3, source TCP port number of 5000 and destination TCP port number of 7000. The source IP address is the same source IP address that was used in the prior, accepted communications. The statistical object matcher 18 compares Ben's statistical object 14F with the plurality of statistical objects 14P, and determines that there it matches two statistical objects, Ben's, and Greg's. The statistical object matcher 18 sends Ben's statistical object 14F, the two matched statistical objects 14M (Ben's and Greg's) and the communications characteristics 22 to the accumulated statistical object selector 20 and sends the communications characteristics 22 to the associated original object selector 24. The accumulated statistical object selector 20 compares Ben's communications characteristics 22 with the plurality of accumulated statistical objects 14AP and finds no matches. Because no matches were found, the accumulated statistical object selector 20 creates a new accumulated statistical object 14A including Ben's statistical object 14F, the two matched statistical objects 14M and the communications characteristics 22. The new accumulated statistical object 14A is added to the plurality of accumulated statistical objects 14AP. The accumulated statistical object information is set to 32 bits to reflect the information contained in statistical object 14F. The accumulated statistical object selector 20 sends the accumulated statistical object 14A to the original object identifier 26.

The original object identifier 26 receives the communications characteristics 22 and compares them with the communications characteristics 22 associated with the plurality of original objects 12P. Because an association exists between Ben's original object and Ben's communications characteristics 22, the associated original object selector 24 selects Ben's original object, indicated as 12SEL and passes the selected original object 12SEL to the associated original object identifier 28.

The original object identifier 26 takes the accumulated statistical object 14A and the selected original object 12SEL (Ben) and ensures that the accumulated statistical object 14A could have been generated from the selected original object 12SEL. Upon determining that the accumulated statistical object 14A was producible by the selected original object 12SEL, the intersection of the original objects 14 is calculated using the original objects associated with the matched statistical objects 14M (Ben and Greg) and the selected original object 12SEL (Ben) resulting in Ben. This intersection is indicated in the accumulated statistical object 14A. Since there is exactly one original object now contained in the accumulated statistical object 14A, the accumulated statistical object 14A is sent to the probability calculator 30.

The probability calculator 30 takes the given accumulated statistical object 14A, and, based on the number of bits of statistical object information that has been accumulated in the accumulated statistical object 14A and the number of statistical objects in the plurality of statistical objects 14P, calculates the probability of guessing the accumulated statistical object information.

In this example, there are 100,000,000 statistical objects and have received 32 bits of statistical object information, but there is only a single statistical object that is associated with the Ben's communications characteristics 22. Therefore, instead of using 100,000,000 as the number of statistical objects, the number of statistical objects is 1, resulting in a calculated probability 36 of p=1/2³². This calculated probability 36 and the accumulated statistical object 22 are passed to the threshold comparator 32. The threshold comparator 32 takes the calculated probability 36 and compares it with the probability threshold value 27. The threshold comparator 32 determines that our calculated probability 27 of p=1/2³² is less than the probability threshold value of 1 in a million. Having not exceeded the probability threshold value 27, the threshold comparator 32 makes an indication 34 that includes the selected original object 12SEL (Ben). This indication 34 communicates to other functions within the device 10 that the communication was sent by Ben and has exceeded the probability threshold value 27 and that the device 10 should now respond to Ben's communication. It should be noted that in this third example, because the communications characteristics 22 associated with the original object 12S are used, it is possible to arrive at a selected original object 12SEL and not exceed the probability threshold value 27 while receiving fewer bits of information from the received (first) statistical object 14F.

### LIST OF REFERENCE CHARACTERS

10 Device (Remote System)
12M Matched Original Object
12P Plurality of Original Objects
12S Original Object
12SEL Selected Original Object
13 Attack Measurement
13A Accumulated Attack Measurement
13P Plurality of Attack Measurements
14A Accumulated Statistical Object
14AP Plurality of Accumulated Statistical Objects
14F First Statistical Object
14M Matching Statistical Object
14MA Matching Accumulated Statistical Object
14MP Plurality of Matching Statistical Objects
14NA New Accumulated Statistical Object
14P Plurality of Statistical Objects
14S Statistical Object
15 Timestamp
16 Communications Receiver
18 Statistical Object Matcher
20 Accumulated Statistical Object Selector
22 Communications Characteristics
24 Associated Original Object Selector
26 Original Object Identifier
27 Probability Threshold Value
28 Associated Original Object Identifier
30 Probability Calculator
32 Threshold Comparator
34 Indication
36 Calculated Probability
38 Time Period
   (All logical components from 12M to 38 may be included in device 10).

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method, comprising:
accepting as input to a device (10) communication of a first statistical object (14F) having communications characteristics (22), the device (10) comprising a table storing a plurality of statistical objects (14P) each corresponding to a respective one of a plurality of original objects (12P), a statistical object matcher (18), an accumulated statistical object selector (20), an original object identifier (26), an attack measurement accumulator, a probability calculator (30), and a threshold comparator (32);
using said statistical object matcher (18) to determine if said first statistical object (14F) matches at least one of said plurality of statistical objects (14P) in said table;
using said statistical object matcher (18) to communicate an attack measurement (13) to said attack measurement accumulator when said first statistical object (14F) matches none of said plurality of statistical objects (14P);
using said accumulated statistical object selector (20) to obtain and accumulate said first statistical object (14F) and a plurality of matched statistical objects (14MP) in an accumulated statistical object (14A) identified by said communications characteristics (22) when said first statistical object (14F) matches at least one of said plurality of statistical objects (14P);
using said original object identifier (26) to determine if said accumulated statistical object (14A) can be produced by exactly one original object (12S) of said plurality of original objects (12P), and selecting the exactly one original object (12S) from said plurality of original objects (12P);
generating an accumulated attack measurement (13A) from a plurality of attack measurements (13P) created by accumulating each attack measurement (13) generated during a time period in which said accumulated statistical object (14A) is accumulated;
using said probability calculator (30) to determine a calculated probability of guessing said accumulated statistical object (14A) based on said accumulated statistical object (14A) and a number of statistical objects in said plurality of said statistical objects (14P) and said accumulated attack measurement (13A);
using said threshold comparator (32) to determine if said calculated probability is less than a threshold value (27); and
generating an indication (34) of said selected original object (12SEL).

2. The method of claim 1, wherein the probability of guessing said first statistical object (14F) remains constant, while the number of statistical objects in said plurality of statistical objects (14P) varies.

3. The method of claim 1, wherein the probability of guessing said accumulated statistical object (14A) remains constant, while the number of statistical objects in said plurality of statistical objects (14P) varies.

4. The method of claim 1, wherein said accumulated statistical object (14A) in said plurality of accumulated statistical objects (14AP) is removed after a period of inactivity pertaining to said accumulated statistical object (14A).

5. The method of claim 1, wherein said threshold value (27) can be changed without coordination with the source of said first statistical object (14F).

6. The method of claim 1, wherein said threshold value (27) can be changed without communication with the source of said first statistical object (14F).

7. The method of claim 1, wherein said threshold value (27) is associated with said selected original object (12SEL).

8. The method of claim 1, wherein said threshold value (27) is associated with said device (10).

9. The method of claim 1, wherein said threshold value (27) is associated with said plurality of original objects (12P).

10. The method of claim 1, wherein said indication (34) includes clock information used in the generation of said first statistical object (14F).

11. The method of claim 1, wherein said indication (34) includes keying information used in the generation of said first statistical object (14F).

12. The method of claim 1, wherein said indication (34) includes state information used in the generation of said first statistical object (14F).

13. The method of claim 1, wherein said indication (34) includes additional information used in the generation of said first statistical object (14F).

14. The method of claim 1, wherein said communications characteristics (22) includes TCP/IP session information.

15. The method of claim 1, wherein said communications characteristics (22) includes addressing information.

16. The method of claim 1, wherein said communications characteristics (22) includes security association information.

17. The method of claim 1, wherein a probability of guessing said first statistical object (14F) remains constant, while the number of attack measurements (13) in said plurality of attack measurements (13P) varies.

18. The method of claim 1, wherein a probability of guessing said first statistical object (14F) accounts for brute force attacks.

19. The method of claim 1, wherein said communications characteristics (22) includes time information.

20. The method of claim 1, wherein said selected original object (12SEL) is determined (22) with said communications characteristics (22) while said statistical object matcher (18) is creating said attack measurement (13) from communications with the same said communications characteristics (22).

21. A method comprising:
accepting as input to a device (10) communication of a first statistical object (14F) having communications characteristics (22), the device (10) comprising therein a plurality of statistical objects (14P), each of the plurality of statistical objects comprising a statistical representation of a corresponding original object (12S), the device comprising storage for a plurality of attack objects (13P), each of the plurality of statistical objects (14P) and the plurality of attack objects (13P) including a timestamp (15), the device (10) comprising a statistical object matcher (18), an accumulated statistical object selector (20), an accumulated statistical object (14A) and a plurality of matching statistical objects (14MP), a first associated original object selector (24), a second associated original object identifier (28) and a table for storing the plurality of statistical objects (14P) and plurality of original objects (12P) and a probability calculator (30);
using the statistical object matcher (18) determining if said first statistical object (14F) matches at least one of said plurality of statistical objects (14P);
using the statistical object matcher (18) to generate an attack measurement (13) when the first statistical object (14F) matches none of said plurality of statistical objects;
accumulating with the accumulated statistical object selector (20) said first statistical object (14F) and a plurality of matching statistical objects (14MP) in the accumulated statistical object (14A) identified by said communications characteristics (22);
using the first associated original object selector (24) the select an original object (12SEL) identified by said communications characteristics (22);
using the second associated original object identifier (28) to determine if said accumulated statistical object (14A) can be produced by said selected original object (12SEL);
generating an accumulated attack measurement (13A) from said plurality of attack measurements (13P) that occurred during a time period during which said accumulated statistical object (14A) was accumulated;
determining with the probability calculator (30) a calculated probability (36) of guessing said accumulated statistical object (14A) based on said accumulated statistical object (14A) and the number of statistical objects in said plurality of said statistical objects (14P) produced by original objects associated with said associated communications characteristics (22) and said accumulated attack measurement (13A);
determining with a threshold comparator (32) if said calculated probability (36) is less than a threshold value (27);
associating said communications characteristics (22) with said selected original object (212SEL); and
generating an indication (34) of said selected original object (12SEL).

22. The method of claim 21, wherein the probability of guessing said first statistical object (14F) remains constant while the number of statistical objects in said plurality of statistical objects (14P) varies.

23. The method of claim 21, wherein the probability of guessing said accumulated statistical object (14A) remains constant, while the number of statistical objects in said plurality of statistical objects (14P) varies.

24. The method of claim 21, wherein said accumulated statistical object (14A) in said plurality of accumulated statistical objects (14A) is removed after a period of inactivity pertaining to said accumulated statistical object (14A).

25. The method of claim 21, wherein said association of communications characteristics (22) with said original object (12S) is removed after a period of inactivity pertaining to said communications criteria (22).

26. The method of claim 21, wherein said association of communications criteria (22) with said original object (12S) is removed after a period of inactivity pertaining to said original object (12S).

27. The method of claim 21, wherein said association of communications criteria with said original object (12S) is created prior to receiving a first statistical object (14F).

28. The method of claim 21, wherein said probability threshold value (27) can be changed without coordination with the source of said first statistical object (14F).

29. The method of claim 21, wherein said probability threshold value (27) can be changed without communication with the source of said first statistical object (14F).

30. The method of claim 21, wherein said probability threshold value (27) is associated with said selected original object (12SEL).

31. The method of claim 21, wherein said probability threshold value (27) is associated with said device (10).

32. The method of claim 21, wherein said probability threshold value (27) is associated with said plurality of original objects (12P).

33. The method of claim 21, wherein said indication (34) includes clock information used in generation of said first statistical object (14F).

34. The method of claim 21, wherein said indication (34) includes keying information used in the generation of said first statistical object (14F).

35. The method of claim 21, wherein said indication (34) includes state information used in the generation of said first statistical object (14F).

36. The method of claim 21, wherein said indication (34) includes additional information used in the generation of said first statistical object (14F).

37. The method of claim 21, wherein said communications characteristics (22) includes TCP/IP session information.

38. The method of claim 21, wherein said communications characteristics (22) includes addressing information.

39. The method of claim 21, wherein said communications characteristics (22) includes security association information.

40. The method of claim 21, wherein the probability of guessing said first statistical object (14F) remains constant, while the number of attack measurements (13) in said plurality of attack measurements (13P) varies.

41. The method of claim 21, wherein the probability of guessing said first statistical object (14F) accounts for brute force attacks.

42. The method of claim 21, wherein said communications characteristics (22) includes time information.

43. The method of claim 21, wherein said selected original object (12SEL) is determined (22) with said communications characteristics (22) while said statistical object matcher (18) is creating said attack measurement (13) from communications with the same said communications characteristics (22).
